(19) United States
(12) Patent Application Publication
(10) Pub. No.: US 2019/0018900 A1
(43) Pub. Date: Jan. 17, 2019

(54) Method and Apparatus for Displaying Search Results

(71) Applicant: Alibaba Group Holding Limited, Grand Cayman (KY)

(72) Inventors: Heng Li, Hangzhou (CN); Shichen Liu, Hangzhou (CN)

(21) Appl. No.: 16/035,063

(22) Filed: Jul. 13, 2018

(30) Foreign Application Priority Data
Jul. 14, 2017 (CN) 201710575606.1

(51) Int. Cl. G06F 17/30; G06N 7/00; G06N 99/00; G06F 3/0482

(52) U.S. Cl. CPC G06F 17/30867; G06N 7/00; G06F 17/30873; G06F 3/0482; G06N 99/005

(57) ABSTRACT

A method of displaying search results, and a related apparatus are provided. The method includes obtaining candidate search results, each candidate search result having a data type to which the respective candidate search result belongs; determining a display ratio of each data type; separately extracting target search results of corresponding data types from the candidate search results according to the display ratio of each data type; and displaying the target search results. By combining a user identifier with personalized information of a user, the present disclosure can dynamically allocate respective numbers of target search results that are displayed for various data types using optimal target parameters.

### CROSS REFERENCE TO RELATED PATENT APPLICATIONS

This application claims priority to Chinese Patent Application No. 201710575606.1, filed on 14 Jul. 2017, entitled “Method and Apparatus for Displaying Search Results,” which are hereby incorporated by reference in its entirety.

### TECHNICAL FIELD

The present disclosure relates to the technical field of computer processing, and particularly to methods and apparatuses for displaying search results, apparatuses, one or more computer readable media.

### BACKGROUND

Along with the rapid development of network technologies, information is generated at a faster and faster pace, with the number of types of information being increased continuously. Under this circumstance, search engines have become one of the important tools for users to obtain information.

As requirements of users become greater, the search engines have been developed from initial keyword matching to today's knowledge search and personalized search. Information that is searched expands from ordinary web pages to various types of data such as encyclopedias, music, movies, novels, commodities, etc. Furthermore, the rise of personalized searches leads to a continued increase in various types of preference data and personalized data of the users.

Generally, a search engine can provide the following search approaches:

1. Inserting various types of search results such as encyclopedias, music, movies, novels, etc., in a search results page

In this approach, although the diversity of search results is guaranteed, a search results page is limited. The number of search results of each type is limited, thus reducing the usage rate of the traffic.

2. Ranking search results according to scores

In this approach, search results are evaluated, and are ordered according to scores of evaluation. A natural result appears in a search results page. However, search results of this type of approach are monotonic, and the search efficiency is relatively low, providing a relatively poor search experience to users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above problems, embodiments of the present disclosure are proposed to provide search result displaying methods, a corresponding search result displaying apparatuses, apparatuses, and one or more computer readable media to overcome the above problems or to solve at least some of the above problems.

In order to solve the above problems, the present disclosure discloses a search result displaying method. The method includes obtaining candidate search results, each candidate search result having a data type to which the respective candidate search result belongs; determining a display ratio of each data type; separately extracting target search results of corresponding data types from the candidate search results according to the display ratio of each data type; and displaying the target search results.

In implementations, the data types include non-personalized data type and personalized data type, and obtaining the candidate search results includes: receiving a search request submitted by a client; extracting a keyword and user information from the search request; and retrieving candidate search results that are related to the keyword and are of the non-personalized data type, and candidate search results that are related to the user information and are of the personalized data type for the search request.

In implementations, determining the display ratio of each data type includes determining optimal target parameters corresponding to different data types; and separately calculating display ratios of the different data types using the optimal target parameters.

In implementations, determining the optimal target parameters corresponding to the different data types includes extracting a contextual feature of a user from the user information; obtaining pre-trained first model parameters; and fitting the optimal target parameters of the data types based on the contextual feature of the user and the first model parameters.

Separately calculating the display ratios of the different data types using the optimal target parameters includes configuring display ratios of corresponding data types based on the optimal target parameters of the data types using a contextual multi-armed bandit model, wherein a data type corresponding an arm in the multi-armed bandit model.

In implementations, the contextual feature of the user includes user tag information and/or data types of search results associated with recent N clicks.

In implementations, the first model parameters are trained using the following approach: collecting contextual features of the user and optimal target parameters of search results; and fitting optimal target parameters of the search results using data types as arms, the contextual features of the users, and a matrix w of which values are to be determined; and setting values of trained matrix Was the first model parameter.

In implementations, separately calculating the display ratios of the different data types using the optimal target parameters includes extracting a current user status from the user information; using the data types as actions and the current user status to form combined features; obtaining pre-trained second model parameters; fitting first Q values using the combined features and the second model parameters under a condition of balancing one or more Q values corresponding to one or more user statuses, and setting the first Q values as optimal target parameters of the actions; and calculating display ratios of data types corresponding to the actions according to the optimal target parameters of the actions.

In implementations, the user status includes user tag information and/or data types of search results associated with recent N clicks.

In implementations, the second model parameters are trained using the following approach: collecting the current user status, a next user status, and optimal target parameters of search results; fitting second Q values using the data types as arms, the current user status, and a matrix w of which values are to be determined; fitting third Q values using the data types as arms, the next user status, and the matrix w of which the values are to be determined; generating an objective function using the optimal target parameters, the second Q values and the third Q values; optimizing the objective function, and calculating the values of the matrix w based on differences between the second Q values and the third Q values; setting the values of the matrix w as the second model parameters.

In implementations, separately extracting the target search results of the corresponding data types from the candidate search results according to the display ratio of each data type includes configuring the data types with numerical intervals, ranges of the numerical intervals being positively correlated with the display ratios; generating a random value; determining a numerical interval to which the random value belongs; and extracting target search results from candidate search results of a data type corresponding to the belonged numerical interval.

In implementations, configuring the data types with numerical intervals includes setting a certain data type as a first target data type; setting data types arranged before the first target data type as second target data types; accumulating display ratios of the second target data types as a starting value; accumulating display ratios of the first target data types and the second target data types as an ending value; setting a region between the starting value and the ending value as a numerical interval of the first target data type.

In implementations, extracting the target search results from the candidate search results of the data type corresponding to the belonged numerical interval includes configuring the data types with data value vectors; recording a number to be displayed in a data value vector corresponding to the numerical interval to which the random value belongs; extracting the target search results from the candidate search results of the data type corresponding to the belonged numerical interval according to the number to be displayed.

In implementations, displaying the target search results includes returning the target search results to a client, the client being used for displaying the target search results.

The embodiments of the present disclosure also disclose a method of displaying search results. The method includes receiving a search request submitted by a user; sending the search request to a server; receiving target search results returned by the server for the search request, wherein the target search results are search results of corresponding data types that are separately extracted from candidate search results according to display ratios of different data types, the candidate search results include retrieved candidate search results of a non-personalized data type that are related to a keyword in the search request, and candidate search results of a personalized data type that are related to user information in the search request; and displaying the target search results.

The embodiments of the present disclosure also disclose a method of displaying search results. The method include obtaining candidate search results, each candidate search result having a data type to which the respective candidate search result belongs; determining personalized display ratios of different data types based on personalized information of a user; separately extracting target search results of corresponding data types from the candidate search results according to personalized display ratios; and providing the target search results to the user.

The embodiments of the present disclosure disclose a search result displaying apparatus. The apparatus includes a candidate search result acquisition module used for obtaining candidate search results, each candidate search result having a data type to which the respective candidate search result belongs; a display ratio determination module used for determining a display ratio of each data type; a target search result extraction module used for separately extracting target search results of corresponding data types from the candidate search results according to the display ratio of each data type; and a display module used for displaying the target search results.

In implementations, the data types include non-personalized data type and personalized data type, and the candidate search result acquisition module includes: a search result receiving sub-module used for receiving a search request submitted by a client; a search result analysis sub-module used for extracting a keyword and user information from the search request; and a candidate search result retrieval sub-module used for retrieving candidate search results that are related to the keyword and are of the non-personalized data type, and candidate search results that are related to the user information and are of the personalized data type for the search request.

In implementations, the display ratio determination module includes an optimal target determination sub-module used for determining optimal target parameters corresponding to different data types; and a ratio calculation sub-module used for separately calculating display ratios of the different data types using the optimal target parameters.

In implementations, the optimal target determination sub-module includes a contextual feature extraction unit used for extracting a contextual feature of a user from the user information; a first model parameter acquisition unit used for obtaining pre-trained first model parameters; and a first fitting unit used for fitting the optimal target parameters of the data types based on the contextual feature of the user and the first model parameters.

The ratio calculation sub-module includes an armed bandit model calculation unit used for configuring display ratios of corresponding data types based on the optimal target parameters of the data types using a contextual multi-armed bandit model, wherein a data type corresponding an arm in the multi-armed bandit model.

In implementations, the contextual feature of the user includes user tag information and/or data types of search results associated with recent N clicks.

In implementations, the first model parameters are trained using the following approach: collecting contextual features of the user and optimal target parameters of search results; and fitting optimal target parameters of the search results using data types as arms, the contextual features of the users, and a matrix w of which values are to be determined; and setting values of trained matrix Was the first model parameter.

In implementations, the ratio calculation sub-module includes a current user status acquisition unit used for extracting a current user status from the user information; a reinforced learning feature combination unit used for using the data types as actions and the current user status to form combined features; a second model parameter acquisition unit used for obtaining pre-trained second model parameters; a second fitting unit used for fitting first Q values using the combined features and the second model parameters under a condition of balancing one or more Q values corresponding to one or more user statuses, and setting the first Q values as optimal target parameters of the actions; and a reinforced learning calculation unit used for calculating display ratios of data types corresponding to the actions according to the optimal target parameters of the actions.

In implementations, the second model parameters are trained using the following approach: collecting the current user status, a next user status, and optimal target parameters of search results; fitting second Q values using the data types as arms, the current user status, and a matrix w of which values are to be determined; fitting third Q values using the data types as arms, the next user status, and the matrix w of which the values are to be determined; generating an objective function using the optimal target parameters, the second Q values and the third Q values; optimizing the objective function, and calculating the values of the matrix w based on differences between the second Q values and the third Q values; setting the values of the matrix w as the second model parameters.

In implementations, the target search result extraction module includes a numerical interval configuration sub-module used for configuring the data types with numerical intervals, ranges of the numerical intervals being positively correlated with the display ratios; a random value generation sub-module used for generating a random value; a numerical interval determination sub-module used for determining a numerical interval to which the random value belongs; and a target search result extraction sub-module used for extracting target search results from candidate search results of a data type corresponding to the belonged numerical interval.

In implementations, the numerical interval configuration sub-module includes a first target data type setting unit used for setting a certain data type as a first target data type; a second target data type setting unit used for setting data types arranged before the first target data type as second target data types; a starting value calculation unit used for accumulating display ratios of the second target data types as a starting value; an ending value calculation unit used for accumulating display ratios of the first target data types and the second target data types as an ending value; a numerical interval determination unit used for setting a region between the starting value and the ending value as a numerical interval of the first target data type.

In implementations, the target search result extraction sub-module includes a data value vector configuration unit used for configuring the data types with data value vectors; a number recording unit used for recording a number to be displayed in a data value vector corresponding to the numerical interval to which the random value belongs; a number extraction unit used for extracting the target search results from the candidate search results of the data type corresponding to the belonged numerical interval according to the number to be displayed.

In implementations, the display module includes a result returning sub-module used for returning the target search results to a client, the client being used for displaying the target search results.

The embodiments of the present disclosure also disclose an apparatus of displaying search results. The apparatus includes a search request receiving module used for receiving a search request submitted by a user; a search request sending module used for sending the search request to a server; a target search result receiving module used for receiving target search results returned by the server for the search request, wherein the target search results are search results of corresponding data types that are separately extracted from candidate search results according to display ratios of different data types, the candidate search results include retrieved candidate search results of a non-personalized data type that are related to a keyword in the search request, and candidate search results of a personalized data type that are related to user information in the search request; and a target search result display module used for displaying the target search results.

The embodiments of the present disclosure also disclose an apparatus, which includes one or more processors; and one or more computer readable media storing instructions that, when executed by the one or more processors, cause the apparatus to perform the method as described above.

The embodiments of the present disclosure also disclose one or more computer readable media storing instructions that, when executed by one or more processors, cause a terminal to perform the method as described above.

The embodiments of the present disclosure have the following advantages.

The embodiments of the present disclosure search for candidate search results from original service object data of certain data types according to a search request of a client, calculate display ratios of the data types based on predefined optimal target parameters corresponding to a user identifier of the client, select target search results from the candidate search results according to the display ratios of the data types, and return the target search results to the client for display. By combining the user identifier with personalized information of a user, the numbers of respective target search results that are displayed for various data types are dynamically allocated using the optimal target parameters. On the one hand, since there are no mandatory requirements for types of search results to display some search results that the user does not like, and there is no need to satisfy the preferences of the user to excessively display certain one or more types of results, the usage rate of the traffic is guaranteed through balancing between the optimal target parameters and personalization of the user for dynamically allocating and ensuring the number of search results that are displayed. In the other hand, non-personalized and/or personalized target search results can be displayed, thus ensuring the diversity of the search results, improving the search efficiency, and providing a better search experience to the user.

By applying the embodiments of the present disclosure, display ratios of different data types to which candidate search results belong can be determined using a display strategic model provided by the embodiments of the present disclosure at a display stage, and the number of search results of each data type that need to be displayed is then calculated according to these display ratios. In other words, these display ratios are used for indicating ratios occupied by data of the different data types in a display data set, and are used as ratios of selection for final target search results. Target search results of corresponding data types can be extracted from the candidate search results based on different data types according to these display ratios. In other words, in a processing logic of the embodiments of the present disclosure, display ratios of different data types are first determined, and a display data set (target search results) is constructed from data of the different data types that is selected according to these display ratios, thus further ensuring the diversity of the search results that are displayed. This takes into account of both non-personalized target search results and personalized target search results, and greatly improves the efficiency of user searches, thereby reducing various types of consumption of resources that are related to the searches.

### BRIEF DESCRIPTION OF THE DRAWINGS

FIG. 1 is a schematic diagram of an existing search results page.

FIG. 2 is a schematic diagram of another existing search results page.

FIGS. 3A-D are flowcharts of a method of displaying search results in accordance with a first embodiment of the present disclosure.

FIGS. 4A and 4B are example diagrams of a type of commodity data in accordance with an embodiment of the present disclosure.

FIG. 5 is a flowchart of a method of displaying search results in accordance with a second embodiment of the present disclosure.

FIG. 6 is a flowchart of a method of displaying search results in accordance with a third embodiment of the present disclosure.

FIG. 7 is a structural block diagram of an apparatus of displaying search results in accordance with a first embodiment of the present disclosure.

FIG. 8 is a structural block diagram of an apparatus of displaying search results in accordance with a second embodiment of the present disclosure.

FIG. 9 shows an exemplary system that can be used for implementing various embodiments described in the present disclosure.

### DETAILED DESCRIPTION

In order to make the above goals, features and advantages of the present disclosure to be understood more easily, the present disclosure is described in further detail in conjunction with accompanying drawings and particular implementations.

The concepts of the present disclosure are susceptible to various modifications and alternative forms. Particular embodiments thereof have been shown in a form of drawings, and will be described in detail herein. It should be understood, however, that the above content is not intended to limit the concepts of the present disclosure to particular forms that are disclosed. Rather, the specification and appended claims of the present disclosure are intended to cover all modifications, equivalents, and alternatives.

“An embodiment”, “embodiments”, and “a particular embodiment” etc., in the present specification represent that the described embodiments may include particular features, structures, or characteristics. However, each embodiment may or may not necessarily include these particular features, structures or characteristics. Moreover, such phrases do not necessarily refer to the same embodiment. In addition, when a particular feature, structure, or characteristic is described in connection with an embodiment, whether explicitly described or not, it can be considered that such feature, structure or characteristic is also related to other embodiments within the knowledge of one skilled in the art. Furthermore, it should be understood that items included in a list in a form of “at least one of A, B, and C” may include the following possible items: (A); (B); (C); (A and B); (A and C); (B and C); or (A, B and C). Similarly, items listed in a form of “at least one of A, B or C” may mean (A); (B); (C); (A and B); (A and C); (B and C); or (A, B, and C).

In some cases, the disclosed embodiments may be implemented as hardware, firmware, software, or any combination thereof. The disclosed embodiments can also be implemented as instructions that are carried or stored in one or more non-transitory machine-readable (e.g., computer-readable) storage media. The instructions can be executed by one or more processors. A machine-readable storage media may be implemented as a storage device, mechanism, or other physical structure used for storing or transmitting information in a form that can be read by a machine (e.g., volatile or non-volatile memory, a media disk, other media, or other physical structural device).

In the drawings, some structural or method features may be shown in a particular arrangement and/or order. Nevertheless, in implementations, such specific arrangement and/or order are not necessary. Rather, in some embodiments, such features may be arranged in different manners and/or orders, rather than the ones as shown in the drawings. Moreover, content included in a particular feature in a structure or method in a particular drawing is not meant to imply that such feature is essential in all embodiments. Moreover, in some embodiments, this feature may not be included, or this feature is combined with other features.

In a context of massive data on the Internet, search engines have become one of the important tools for users to obtain information. The speed of data generation is getting faster and faster, and the number of categories thereof is also increasing, along with increasingly higher demands from users, from initial keyword matching to today's knowledge search and personalized search. Data retrieved by a search engine also varies from ordinary web pages to various types of data such as encyclopedias, music, movies, novels, commodities, and the like. At the same time, the rise of personalized search has led to a continued increase in user preference data and personalized data. In view of such a large number of types of data, how to use a limited search results page to provide users with the most satisfactory service has become a very challenging topic.

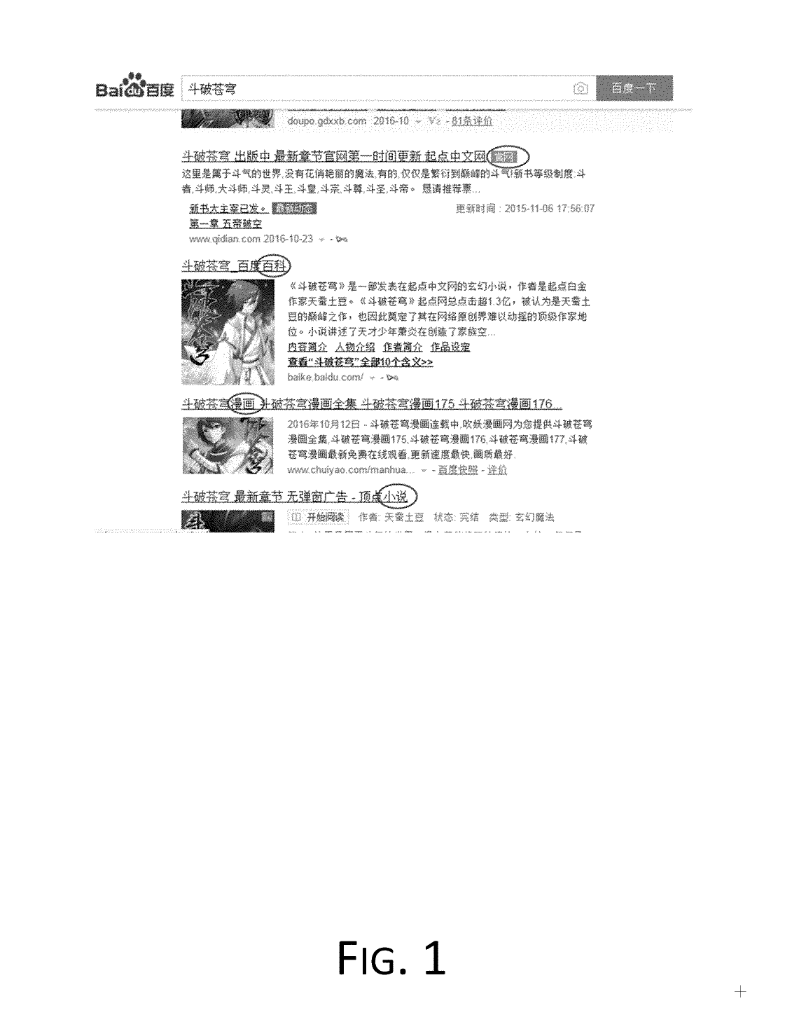

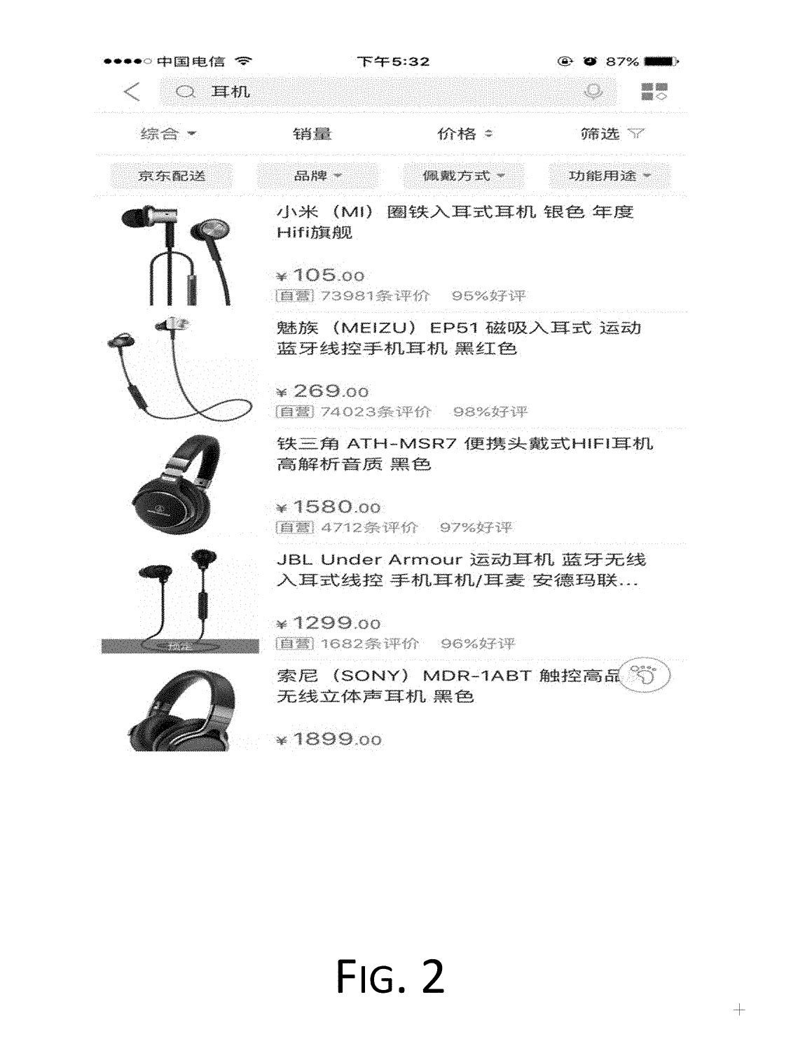

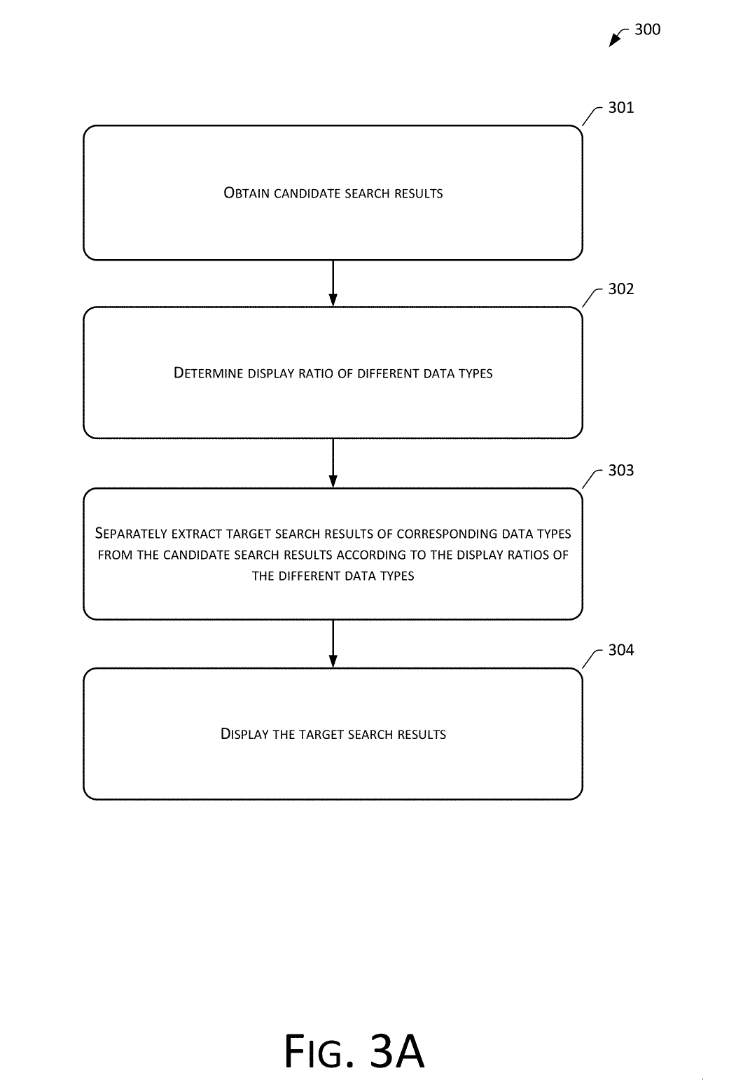

Referring to schematic diagrams of two types of search results pages as shown in FIG. 1 and FIG. 2, search engines can generally provide the following search methods.

First type: Insert various types of results such as encyclopedias, music, movies, and novels, etc., into a search results page

As shown in a search results page of FIG. 1, various types of search results such as encyclopedias, music, movies, and novels, etc., are inserted into the page. By forcing these multiple types of results to the front, users are provided with rich search results.

Although this search method ensures the diversity of search results, the search results page is limited, and the number of each type of search results displayed is also limited, thus reducing the utilization rate of the traffic.

Second type: Sort search results by scores.

In a search results page as shown in FIG. 2, in this approach, scores are calculated for all search results according to search score logic, and the search results are then completely sorted according to the scores. Since the search results are sorted according to the search scores, this causes some types of search results difficult to be revealed on the search results page, and the entire page is presented with natural results. Moreover, simply using the scores of the search results, there is a lack of overall consideration of the entire page, failing to completely control over the diversity and efficiency of the entire page of the search results, and giving the user a very poor search experience.

In view of the above problems, one of the core concepts of the present disclosure creatively proposed by the inventors of the present disclosure is to explore an optimal solution for a combinative display of a plurality of search types of results in a limited search result page by combining a user's personalized information and search context information. A reasonable number of results are assigned for each search type to achieve a better user experience and greater benefits, without the need of deliberately pursuing the diversity of results to display some search results that users do not like, and without the need of excessively displaying one or several types of results in order to cater the user's preferences. Furthermore, the final search results not only consider natural scores, but also consider the diversity and efficiency of the entire page of results in order to fully improve the effectiveness of the search results.

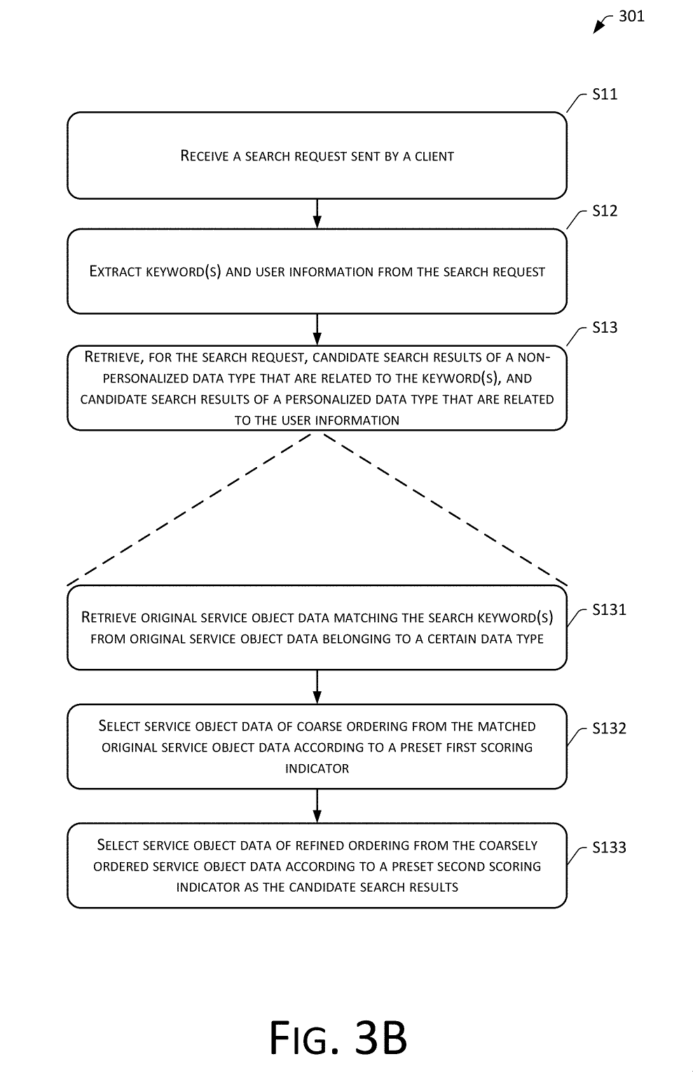

Referring to FIGS. 3A-D, flowcharts of a method 300 for displaying a search result according to a first embodiment of the present disclosure are shown, which may specifically include the following operations.

Operation 301 obtains candidate search results, wherein each candidate search result having a data type to which the respective candidate search result belongs.

An e-commerce platform is used as an example. After a user searches for keywords, a group of search results with good scores can be obtained to form a search result pool, i.e., candidate search results in the embodiments of the present disclosure, after retrieval, coarse ordering and fine ordering (a waterfall flow model). Currently, these candidate search results include not only results retrieved due to non-personalization (i.e., pure keywords) recalls, but also results retrieved based on personalized features of the user such as favorite stores, brands, and commodities, etc.

It can be understood that data types may include a non-personalized data type and a personalized data type. In this case, operation 301 may include the following sub-operations.

Sub-operation S11 receives a search request sent by a client.

In implementations, the embodiments of the present disclosure can be applied to a search engine. The search engine can be deployed in an independent server or a server cluster, such as a distributed system, which stores a massive amount of services object data of different fields.

The service object data is data reflecting the characteristics of an associated domain.

For example, in a communication field, service object data may be communication data. In a news media field, service object data may be news data. In an electronic commerce (EC) field, service object data may be commodity data, etc.

In different fields, although service object data bears different characteristics of the fields, an essence thereof is all data, such as text data, image data, audio data, video data, etc., and relatively, processing of the service object data is essentially processing of the data.

In the embodiments of the present disclosure, original service object data, coarse service object data, refined service object data, candidate search results, target search results, etc., are the same in a logical sense, and an essence thereof is all service object data.

Sub-operation S12 extracts keyword(s) and user information from the search request.

In order to enable one skilled in the art to understand the present disclosure in a better manner, commodity data is used as an example of a business object for description in the embodiments of the present disclosure.

A search request for service object data may refer to an instruction for searching related service object data that is sent by a client (e.g., a browser). For a search engine, the search request corresponds to the traffic of a network (traffic, an access volume of a website).

Under normal circumstances, the traffic of a search engine may be the traffic of the search engine on its own, or may be the traffic introduced from an external (server). Therefore, a user may operate in a search engine or other website to trigger a search request for service object data.

For example, a user may search for a search keyword on a search engine page to trigger a search request for service object data, or may browse related web pages on other websites to trigger a search request for service object data, or may also click on a logo on other websites to trigger a search request for service object data, etc.

Sub-operation S13 retrieves, for the search request, candidate search results of a non-personalized data type that are related to the keyword(s), and candidate search results of a personalized data type that are related to the user information.

In the embodiments of the present disclosure, the search engine may deploy a database to store service object data of different data types as original service object data.

For commodity data, a personalized data type may include service object data retrieved due to the user's personalized preference brands, stores, commodities, and the like.

If a search engine receives a search request sent by a client, the search engine may respond to the search request and retrieve relevant service object data from original service object data as candidate search results.

In implementations, the search request has a user identifier, that is, information that can represent a uniquely determined user, for example, a user account, cookies, and the like. In the embodiments of the present disclosure, sub-operation S13 may further include the following sub-operations S131-133.

S131 retrieves original service object data matching the search keyword(s) from original service object data belonging to a certain data type.

S132 selects service object data of coarse ordering from the matched original service object data according to a preset first scoring indicator.

S133 selects service object data of refined ordering from the coarsely ordered service object data according to a preset second scoring indicator as the candidate search results.

The second scoring indicator is more than the first scoring indicator.

In the embodiments of the present disclosure, a user may input a search keyword, such as a dress, on a search engine page or the like to trigger a search request.

As such, the search request includes the keyword. The search engine can extract the search keyword, and retrieve from the database original service object data which information such as a title, a text, etc., matches the search keyword.

For the retrieved original service object data, the original service object data may be scored using a first scoring indicator (i.e., a scoring rule), and a portion of the original service object data with highest partial scores is taken as service object data of coarse ordering for a next round of screening.

For the service object data of the coarse ordering, a second ranking indicator (i.e., a scoring rule) may be used to score the service object data of the coarse ordering, and a portion of the service object data of the coarse ordering with highest scores may be taken as refined service object data of refined ordering to obtain final candidate search results.

Apparently, in addition to using the search keyword(s) for matching, the search engine may also search for the candidate search results through other methods, for example, matching through the user's operation mode, channels of the traffic, etc., which are not limited in the embodiments of the present disclosure.

Operation 302 determines display ratio of different data types.

One of the core processes in the embodiments of the present disclosure is to determine display ratios of different data types for candidate search results using a display strategy model provided in the embodiments of the present disclosure at a display stage, and then calculate the number of search results of each data type that needs to be displayed according to the display ratios. In other words, these display ratios are used for indicating ratios occupied by data of the different data types in a display data set, and are used as ratios of selection for final target search results. Target search results of corresponding data types can be extracted from the candidate search results based on different data types according to these display ratios. In other words, in a processing logic of the embodiments of the present disclosure, display ratios of different data types are first determined, and a display data set (target search results) is constructed from data of the different data types that is selected according to these display ratios.

In implementations, operation 302 may include the following sub-operations.

Sub-operation S21 determines optimal target parameters corresponding to different data types.

Sub-operation S22 separately calculates the display ratios of different data types using the optimal target parameters.

In the embodiments of the present disclosure, the search engine provides a display strategy model, which can seek a display solution of search results for a current user (characterized by user information), to obtain the number displayed for each data type, and to balance user experience with a search target. An optimal target parameter in the embodiments of the present disclosure refers to a target that needs to be optimized or a demand that needs to be achieved in one search in practice, or called a search indicator. For example, for a search target as displaying an enough number of results for a user in each search to allow the user to select, a corresponding optimal target parameter can be set as an accuracy rate of screening of search results. Alternatively, for example, for a search target as the cost per search (e.g., time consumption, etc.) not exceeding an upper limit of a search engine, a corresponding optimal target parameter can be set as a total cost coefficient used for processing search results that enter a certain screening layer (fine or coarse ordering). For another example, for commodity data, a value of a transaction volume, a click through rate (CTR), a click value rate (CVR), etc., can be used as optimal target parameters.

In practice, one skilled in the art can set an optimal target parameter according to actual needs, which is not limited in the embodiments of the present disclosure.

It should be noted that the display strategy model provided in the embodiments of the present disclosure does not force page diversification, for example, specifying the number of service object data of each type. Rather, long-term (e.g., user portraits, tags) and short-term (such as real-time click information) of personalized information of a user, and algorithms such as reinforcement learning, are used to explore a better display strategy with a rational use of online traffic.

As an example of a specific application of the embodiments of the present disclosure, sub-operation S21 may further include the following sub-operations S211-S213.

S211 extracts contextual features of the user from the user information.

S212 acquires first model parameter(s) that is/are trained in advance.

S213 fits an optimal target parameter of each data type using the contextual features of the user and the first model parameter(s).

In the embodiments of the present disclosure, a contextual multi-armed bandit model may be used for calculating a display ratio of each data type.

In this algorithm, there are k (k is a positive integer) arms corresponding to display ratios of n data types.

In implementations, the search engine may query user tag information (such as a gender, an age, a purchasing power, etc.) and/or data types of recent N (N is a positive integer) clicked search results as contextual features of the user.

By applying the embodiments of the present disclosure, first model parameters of the multi-armed bandit model can be trained in advance offline.

In implementations, the first model parameters may be trained as follows:

collecting contextual features of a user, and optimal target parameters of search results;

fitting the optimal target parameters of the search results using data types as arms, the contextual features of the user, and a matrix w of which values are to be determined; and

taking the values of the trained matrix W as the first model parameters.

A search results page is assumed to have 10 search results. Data types, which act as arms, are assumed to be a₀, a₁, . . . , a₉ respectively. Optimal target parameters of each search results (such as purchase amounts of a user for each search result) are assumed to be r₀, r₁, . . . , r₉ respectively. User contextual features of a group of users are x=(x₀, x₁, . . . , xₖ₋₁).

The data type a₀ is represented as a=(0, . . . 1, . . . , 0), with the a₀^{th} as 1, and others as 0. The others are done in the same manner.

x₀=1 represents that an associated user has such user contextual feature. If x₀ =0, this represents that an associated user does not have such user contextual feature. The others are done in the same manner.

A linear expression aWx^{T} is used to fit an optimal target parameter r₀, where the matrix W is first model parameters, and the rest is analogously generated, resulting in 10 samples, from which values of W are trained.

If the search engine receives a search request from a certain user (characterized by user information) online, contextual features of the user may be queried in real time. Using data types as arms, the contextual features of the user, and values of the model parameters that have been calculated, an optimal target parameter of each arm is fitted according to a linear relationship (e.g., aWx^{T}).

In implementations, sub-operation S22 may be: using a contextual multi-armed bandit model to configure display ratios of corresponding data types according to the optimal target parameter of each data type.

In implementations, a relationship between an optimal target parameter of an arm and a display ratio of the arm may be set in advance based on a type of the optimal target parameter, the display ratio of the arm may be configured according to the relationship in real time.

It should be noted that the optimal target parameter usually considers an optimal target parameter after the arm is implemented at this time, without considering the influence on future user behavior and the influence on a future optimal target parameter after the arm is implemented.

For commodity data, if a transaction amount is used as an optimal target parameter, an optimal target parameter of an arm may be positively related to a display ratio of the arm. In other words, the higher the optimal target parameter of the arm is, the greater the display ratio of the arm is. Otherwise, the lower the optimal target parameter of the arm is, the smaller the display ratio of the arm is.

Apparently, for other optimal target parameters, an optimal target parameter of an arm may also be negatively related to a display ratio of the arm, which is not limited in the embodiments of the present disclosure.

A LinUCB method is used as an example. A display ratio of each arm can be calculated for a linear expression aWx^{T}.

In the LinUCB method, a parameter \alpha may be set, and a test iteration may be started.

A feature vector xa,t for each arm is obtained.

An estimated return and a confidence interval for each arm are calculated.

If an arm has not been tested, then:

Aa is initialized with an identity matrix, ba is initialized with 0 vectors, and the untested arm is completely processed.

A linear parameter \theta is calculated, the estimated return is calculated using \theta and the feature vector xa,t, and a width of the confidence interval is added to process each arm.

Based on the estimated return of each arm and a value of the width of the confidence interval, a display ratio of each arm is formed in an equal proportion. Online display is made according to these probabilities. A true return rt of each arm is collected. Aat is updated, and bat is updated.

In LinUCB, aW is a parameter \theta corresponding to an arm.

Therefore, in implementations, sub-operation S22 may further include the following sub-operations S221-S225.

S221 extracts a current user state from the user information.

Since activities of the user are coherent, there are links to find. If the search engine is regarded as a robot and the user is regarded as the environment, a reinforcement learning model (such as Q learning) can be used to model an interaction process between the search engine and the user, and to calculate a respective display ratio of each data type, thus ensuring future optimal target parameters carried in the links.

It should be noted that, unlike the multi-armed bandit, revenue indicators considered in the reinforcement learning are not only current optimal target parameters, but also optimal target parameters of the interaction process.

Q(s,a) is assumed to represent an optimal target parameter that is obtained when a user is in a s user state and after a search engine delivers a display ratio a of service object data until interactions between the user and the search engine (including continuous search activities thereafter) ends. This optimal target parameter is not merely an optimal target parameter obtained on a current search results page after the search engine delivers the display ratio a of the service object data.

In implementations, the search engine may query user tag information (such as a gender, an age, a purchasing power, etc.) and/or data types of recent N (N is a positive integer) clicked search results as the user status.

S222 takes the data type as an action, and combines the current user status therewith to form a combined feature.

S223 acquires previously trained second model parameters.

As an example of a specific application of the embodiments of the present disclosure, a second model parameter of a Q learning model may be pre-trained offline in the following manner:

collecting a current user status, a next user status, and optimal target parameters for search results;

fitting a second Q value using data types as arms, the current user status and a matrix w of which values to be determined;

fitting a third Q value using the data types as the arms, the next user status and the matrix w of which the values to be determined;

generating an objective function using the optimal target parameters, the second Q value and the third Q value;

optimizing the objective function, calculating the values of the matrix w based on a difference between the second Q value and the third Q value;

setting the values of the matrix w as the second model parameters.

S224 fits the first Q value using the combined feature and the second model parameters under a condition of balancing one or more Q values corresponding to one or more user statuses in the future, and uses the first Q value as an optimal target parameter of the motion.

A search results page is assumed to have 10 search results, and data types thereof, which act as actions, are assumed to be a₀, a₁, . . . , a₉ respectively. Optimal target parameters of each search results (such as purchase amounts of a user for each search result) are assumed to be r₀, r₁, . . . r₉ respectively. A current user status of the user is s, and a next user status is s′, then samples that are generated are (s, a₀, s′, r₀), . . . , (s, a₉, s′, r₀).

A Q learning method is used to learn the samples. Q values (which include a second Q value and a third Q value) are approximated using a linear model, such that Q(s, a, w)=wx^{T}, where x is a combined feature formed by a user status s and an action a, and w is a second model parameter.

In the embodiments of the present disclosure, a value of the second model parameter is calculated based on a difference between the second Q value and the third Q value, so that the difference between the second Q value and the third Q value is generally minimized.

In implementations, the second model parameter may be solved by optimizing the following objective function:

$${arg min}_{w} \frac{1}{2 N} {\sum }_{i} {[ r + γ {max}_{{a}^{′}} Q ( {s}^{′} , {a}^{′} , \overline{w} ) - Q ( s , a , w ) ]}^{2}$$

w̅ it is a second model parameter of a previous iteration, i.e., is a known value. w is a second model parameter to be learned in a current iteration. r is a discount of a future optimal target parameter, and can be set as 0.8, for example.

If the search engine receives a search request for a certain user (represented by a user identifier) online, a user status of the user (characterized by the user identifier) may be queried in real time. An optimal target parameter of each action is fitted according to a linear relationship (e.g., Q(s, a, w)=wx^{T}) using data types as actions, the user status, and the calculated values of the second model parameters.

S225 calculates display ratios of respective data types corresponding to the actions according to respective optimal target parameters of the actions.

In implementations, relationships between optimal target parameters of actions and display ratios of the actions may be set in advance based on types of the optimal target parameters, and the display ratios of the actions are configured according to the relationships in real time.

For commodity data, if a transaction amount, etc. is treated as an optimal target parameter, an optimal target parameter of an action can be positively related to a display ratio of the action. In other words, the higher the optimal target parameter of the action is, the greater the display ratio of the action is. Otherwise, the lower the optimal target parameter of the action is, the smaller the display ratio of the action is.

Apparently, for other optimal target parameters, optimal target parameters of actions may also be negatively related to display ratios of the actions, which is not limited in the embodiments of the present disclosure.

In implementations, if a current user state of a user is s, first Q values under each action are calculated as Q(s, a, w). A display ratio of an action aᵢ can be calculated using the following function:

$$P ( {a}_{i} ) = \frac{{e}^{\frac{Q ( s , {a}_{i} , w )}{τ}}}{{\sum }_{k}^{K} {e}^{\frac{Q ( s , {a}_{k} , w )}{τ}}}$$

This function is a softmax function (regression function). When the function Q(s, a, w) is larger, a display ratio of a corresponding action is larger. When the function Q(s, a, w) is smaller, a display ratio of a corresponding action is smaller.

τ>0 is a smoothing constant, which can be determined by experience. When τ is larger, display ratios will become more even. When τ is smaller, the display ratios will become more uneven.

Apparently, the above method of calculating display ratios is only an example. When the embodiments of the present disclosure are implemented, other methods of calculating display ratios, for example, deterministic policy gradient, etc., may be set according to an actual situation which is not limited by the embodiments of the present disclosure. In addition, besides the above method of calculating display ratios, one skilled in the art can also use other methods of calculating display ratios according to actual needs, and the embodiments of the present disclosure do not have any limitation thereon.

Operation 303 separately extracts target search results of corresponding data types from the candidate search results according to the display ratios of the different data types.

If a display ratio of each data type is calculated through the display strategy model, the number of search results that need to be displayed to the user can be assigned to each data type according to the display ratios as the target search results.

In implementations, operation 303 may include the following sub-operations:

Sub-operation S31 configures numerical intervals for the data types.

In the embodiments of the present disclosure, a range of a numerical range is positively related to a display ratio. In other words, when the display ratio is larger, the range of the numerical interval is larger. When the display ratio is smaller, the range of the numerical interval is smaller.

In implementations, sub-operation S31 may include the following sub-operations S311-S315:

S311 sets a certain data type as a first target data type.

S312 sets data type(s) prior to the first target data type as second target data type(s).

S313 accumulates display ratio(s) of the second target data type(s) as a starting value.

S314 accumulates display ratios of the first target data type and the second target data type(s) as an ending value.

S315 sets a region between the starting value and the ending value as a numerical interval of the first target data type.

Service object data is assumed to have n (n is a positive integer) data types with display ratios thereof being (prob₀, prob₀, . . . , probₙ₋₁). Correspondingly, numerical intervals are calculated as (acc₀, acc₁, acc₂, . . . , accₙ)

=(prob₀, prob₀+prob₁, prob₀+prob₁+prob₂, . . . , prob₀+prob₁+ . . . +probₙ₋₁)

A third data type is taken as an example. The third data type is set as a first target data type, i.e., a first data type and a second data type as a second target data type.

A numerical interval acc₂ of the third data type has a starting value of prob₀+prob₁, and an ending value of prob₀+prob₁+prob₂.

It should be noted that a starting value and an ending value may be contact points between two adjacent numerical intervals, and may be set to belong to a previous numerical interval or set to belong to the following numerical interval. The embodiments of the present disclosure do not have any limitation thereon.

For example, a range of the numerical interval acc₂ of the third data type may be (prob₀+prob₁, prob₀+prob₁+prob₂), or [prob₀+prob₁, prob₀+prob₁+prob₂), or (prob₀+prob₁, prob₀+prob₁+prob₂], or [prob₀+prob₁, prob₀+prob₁+prob₂].

Apparently, the above configuration of numerical intervals is only an example. When the embodiments of the present disclosure are implemented, other configurations of numerical intervals may be set according to actual conditions, which are not limited in the embodiments of the present disclosure. In addition, besides the above configuration of numerical intervals, one skilled in the art can also adopt other configurations of numerical intervals according to actual needs, and the embodiments of the present disclosure do not have any limitations thereon.

Sub-operation S32 generates a random value.

In implementations, a randomly generated random value is generally within a range of a numerical interval.

For example, if a sum of display ratios of all data types is 1, a numerical interval is configured through sub-operation S411 to sub-operation S415, and the random value belongs to [0, 1].

Sub-operation S33 determines a numerical interval to which the random value belongs.

Through respective relationships of the random value with a starting value and an ending value of each numerical interval, a numerical interval to which the random value belongs can be determined.

Sub-operation S34 extracts target search results from candidate search results belonging to a data type corresponding to the numerical interval.

A numerical interval of each data type is assumed to be (acc₀, acc₁, acc₂, . . . , accₙ), and a random value that is generated is assumed to be r. If r≤acc₀, a data type corresponding thereto is 0, that is, the first data type. Accordingly, target search results can be selected from candidate search results that belong to the first data type. If acc₀≤r≤acc₁, a data type corresponding thereto is 1, that is, the second data type. Accordingly, target search results can be selected from candidate search results belonging to the second data type, and so on.

In implementations, sub-operation S34 may include the following sub-operations S341-S343:

S341 configures numerical vectors for the data types.

In implementations, a corresponding numerical vector can be configured for each data type, which is denoted as:

N\vec{U}M =(num₀, num₁, num₂, . . . , numₙ₋₁)

that represents respective quantities of target search results to be displayed for data type 0 through data type n, which are initialized to zero.

S342 records a quantity to be displayed in a numerical vector corresponding to the numerical interval to which the random value belongs.

Each time when a random number is randomly generated, a numerical vector of a corresponding data type in N\vec{U}M=(num₀, num₁, num₂, . . . , numₙ₋₁) can be added by one, as the number to be displayed.

If a total of M target search results are displayed, a total of M random values are generated, and M values are accumulated in the numerical vector.

S343 extracts the target search results from the candidate search results belonging to the data type corresponding to the numerical interval according to the quantity to be displayed.

When each data type is determined according to a random value, an accumulated quantity to be displayed can be extracted from the numerical vector, and target search results can be extracted from corresponding candidate search results.

In implementations, when the candidate search results belonging to the data type corresponding to the numerical interval is refined service object data, the refined service object data may be evaluated with scores according to the second scoring indicator. Therefore, the refined service object data can be extracted in an order of the scores.

Operation 304 displays the target search results.

In implementations, in response to obtaining the target search results, the server returns the target search results to the client, and the target search results are displayed at the client.

For example, a search engine may provide a feedback to a search request of a client, and push target search results that are found to the client. The client loads the target search results into a search results page for display to the user.

If an application server and a resource server are deployed in a cluster of computers such as a distributed system, the application server determines target search results after receiving a search request from a client, and requests data content of the target search results from the resource server according to IDs of the target search results. The data content is then returned to the client for display on a search results page.

In the embodiments of the present disclosure, candidate search results are retrieved from original business object data belonging to a certain data type according to a search request of a client. A display ratio of the data type is calculated for a user identifier of the client based on a preset optimal target parameter. According to the display ratio of the data type, target search results are selected from the candidate search results, and are returned to the client for display. By combining the user identifier with personalized information of a user, the numbers of respective target search results that are displayed for various data types are dynamically allocated using optimal target parameters. On the one hand, since there are no mandatory requirements for types of search results to display some search results that the user does not like, and there is no need to satisfy the preferences of the user to excessively display certain one or more types of results, the usage rate of the traffic is guaranteed through balancing between the optimal target parameters and personalization of the user for dynamically allocating and ensuring the number of search results that are displayed. In the other hand, non-personalized and/or personalized target search results can be displayed, thus ensuring the diversity of the search results, improving the search efficiency, and providing a better search experience to the user.

In order to make one skilled in the art to understand the embodiments of the present disclosure in a better manner, commodity data is used as an example of service object data for illustration in the present specification.

A user activates a browser, loads a web page of a shopping website in the browser, enters a search keyword “dress” in a search field of the web page, and sends the search keyword to the shopping site by pressing an enter key, and clicking to confirm a control, etc.

A search engine is deployed in the shopping site, and the search engine retrieves commodity data matching the search keyword “dress”.

For the retrieved commodity data, a coarse ordering is performed by through two first scoring indicators:

1. Whether a category matches a category queried by the user.

Although some commodity data have the search keyword “dress” in the title, a category thereof does not match.

2. Popularity of commodity data.

Scores of the two first scoring indicators are added together, to obtain an approximate and relatively rough score. A small number of commodity data with relatively high scores (service object data of a coarse ordering) are taken into a next round.

For the commodity data after the coarse ordering, refined ordering can be made through the following second scoring indicators: an estimate of click-through rate, an estimate of a conversion rate, and an estimate of a degree of matching between a commodity and a user, and some real-time scores.

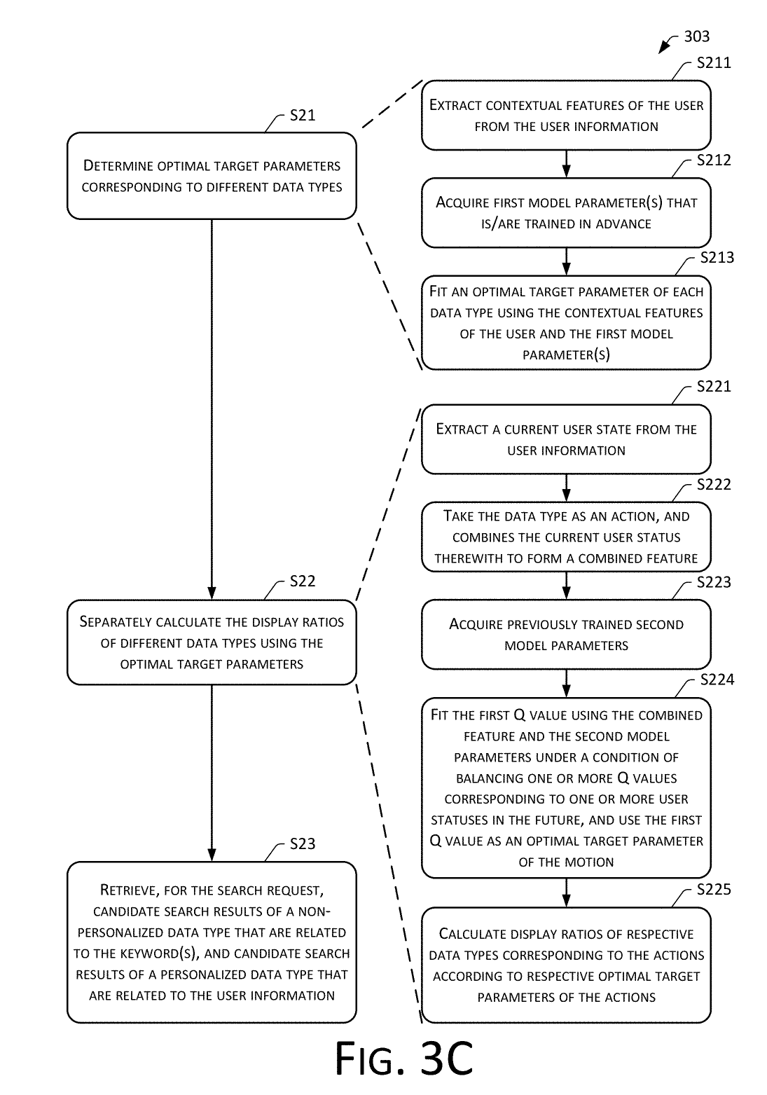

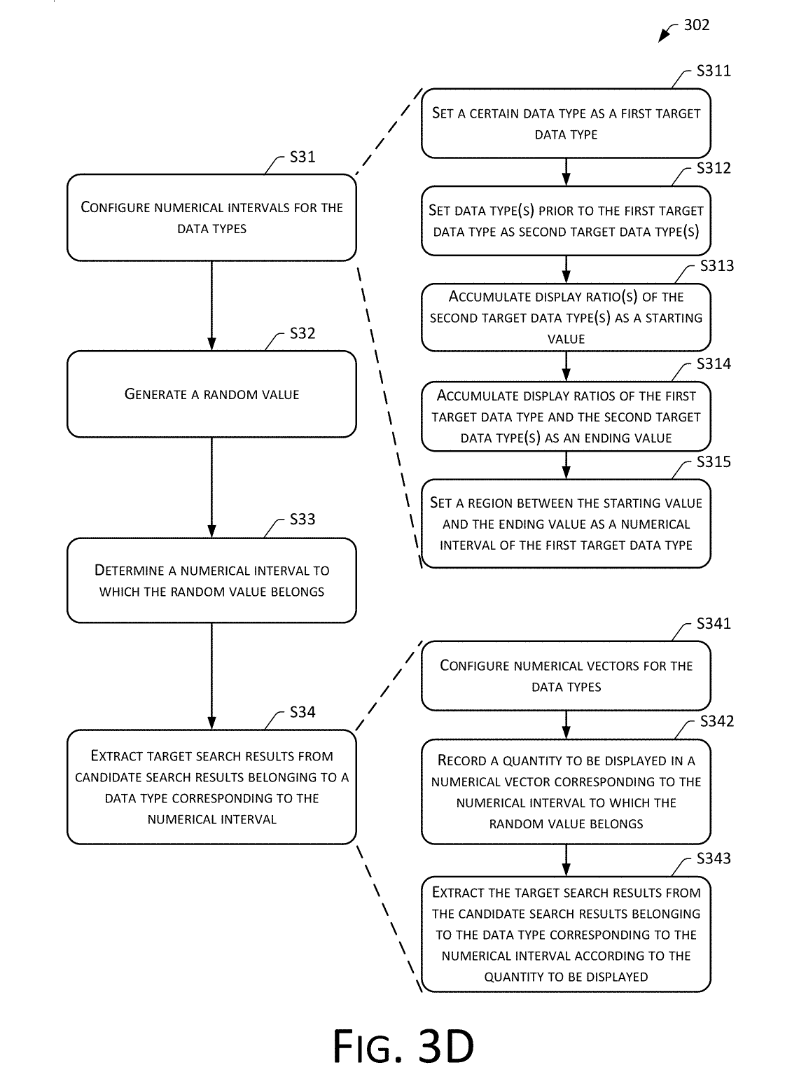

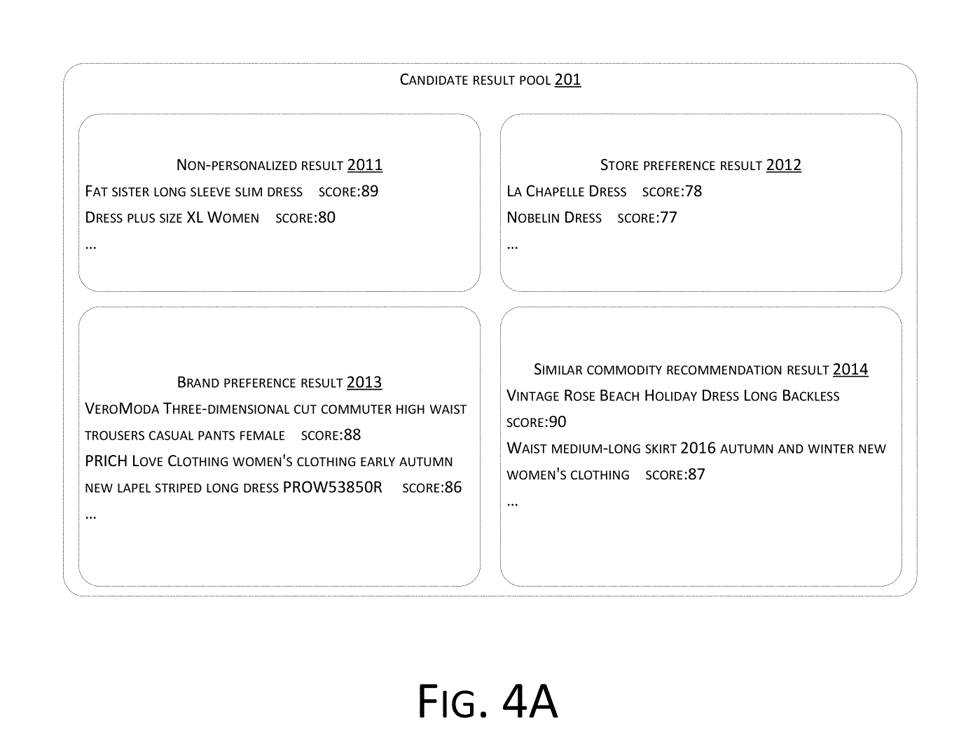

Scores of these second scoring indicators are combined to obtain a comprehensive score of the commodity data, and a small amount (for example, 500) of relatively high-scored commodity data (service object data of refined ordering) is taken, and entered into the candidate result pool 201 as shown in FIG. 4A.

Four types of commodity data exist in the candidate result pool 201, which are a non-personalized result 2011, a store preference result 2012, a brand preference result 2013, and a similar commodity recommendation result 2014, where score is a rating.

If a contextual multi-armed bandit algorithm is used, then tag attributes (such as a gender, an age, a purchasing power, etc.) of the user and categor(ies) of commodit(ies) that the user has recently clicked in real time can be taken as contextual features of the user, which are expressed as x. A linear expression aWx^{T} is used to estimate a transaction volume r₀, where a is an arm (i.e., a data type) and W is a model parameter.

Using the LinUCB method, a display ratio of each arm (ie, a type of commodity data) is calculated.

A tag of the current user is assumed to be (male, 25 years old, 3-level purchase power), and estimations are performed for the user on 10 arms separately.

For example, for arm1, three characteristics <male arm1, 25 years old arm1, and 3-level purchasing power arm1> are separately multiplied by weights thereof to obtain an estimated transaction volume. For arm2, three characteristics <male arm2, 25 year old arm2, and 3-level purchasing power arm2> are separately multiplied by weights thereof to obtain an estimated revenue.

If a Q learning algorithm is used, types of search results associated with previous four clicks of the current user and user tag information may be used as a user state, which is represented as s. A type of commodity data is represented as a, and a transaction volume of the user for these search results is represented as r₀.

Q (s, a, w)=wx^{T}, x is a combined feature formed by the status s and an action a.

Each Q(s, a, w)=wx^{T} is separately calculated to obtain 1, 1.1693, 1.693, and 2.61 respectively. Given τ=1, a display ratio among the non-personal result 2011, the store preference result 2012, the brand preference result 2013, and the similar commodity recommendation result 2014 are calculated to be 1:2:2:5 using the following formula:

$$P ( {a}_{i} ) = \frac{{e}^{\frac{Q ( s , {a}_{i} , w )}{τ}}}{{\sum }_{k}^{K} {e}^{\frac{Q ( s , {a}_{k} , w )}{τ}}}$$

In other words, display ratios are 0.1, 0.2, 0.2, and 0.5 respectively.

For the non-personalized result 2011, a numerical interval [0, 0.1] and a numerical vector are configured. A numerical interval (0.1, 0.3) and a numerical vector are configured for the store preference result 2012. A numerical interval (0.3, 0.5) and a numerical vector are configured for the brand preference result 2013. The similarity product recommendation result 2014 is configured with a numerical interval (0.5, 1) and a numerical vector.

A random value r is generated, and is assumed to be 0.75. As such, the numerical vector of the similar product recommendation result 2014 is accumulated by one.

This is repeated for 10 times. The non-personalized result 2011 has a numerical vector of 1, the store preference result 2012 has a numerical vector of 2, the brand preference result 2013 has a numerical vector of 2, and the similar product recommendation result 2014 has a numerical vector of 5.

From the candidate result pool 201, commodity data corresponding to the highest score in the non-personalized result 2011 is selected, commodity data corresponding to the first two highest scores in the store preference result 2012 are selected, and commodity data corresponding to the first two highest scores in the brand preference result 2013 are selected, and commodity data corresponding to the first five highest scores in the similar product recommendation result 2014 are selected.

As shown in FIG. 4B, these pieces of commodity data are sorted according to respective scores, returned to the browser, and displayed to the user.

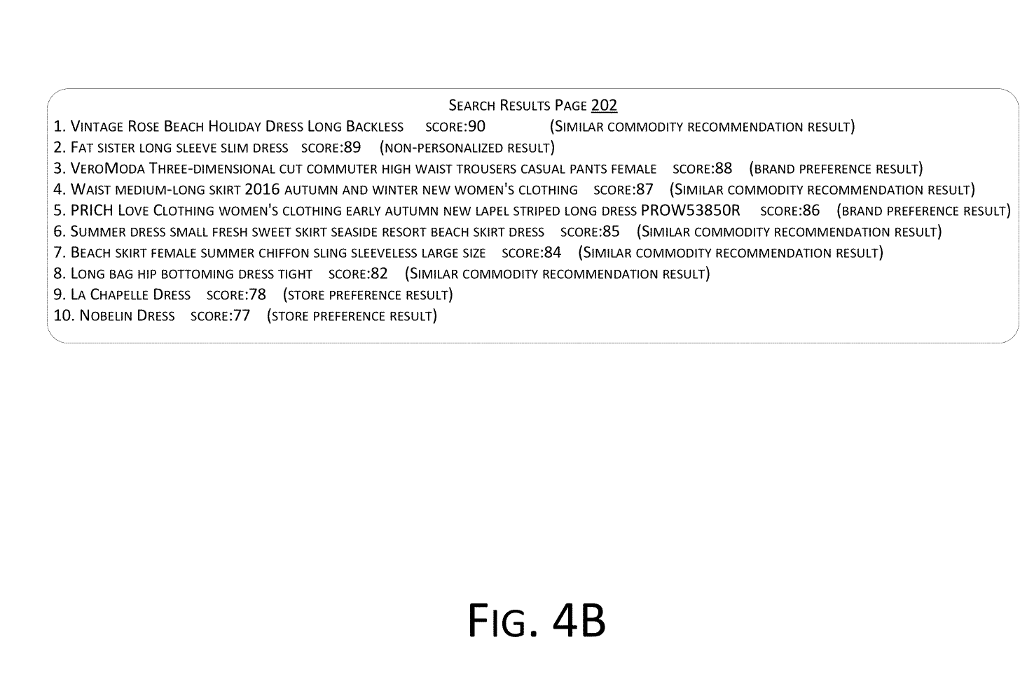

Referring to FIG. 5, a flowchart of a method 500 for displaying search results according to a second embodiment of the present disclosure is shown, which may specifically include the following operations.

Operation 501: Receive a search request submitted by a user.

Operation 502: Send the search request to a server.

Operation 503: Receive target search results returned by the server for the search request.

Operation 504: Display the target search results.

This embodiment of the present disclosure is a solution implementing a purpose of the present disclosure on a client side. In the embodiments of the present disclosure, the target search results may be search results of corresponding data types extracted from respective candidate search results according to display ratios. The display ratios respectively correspond to candidate search results belonging to different data types. The candidate search results may include retrieved candidate search results that are related to keyword(s) in a search request and are of non-personalized data types, and candidate search results that are related to user information in the search request and are of personalized data types.

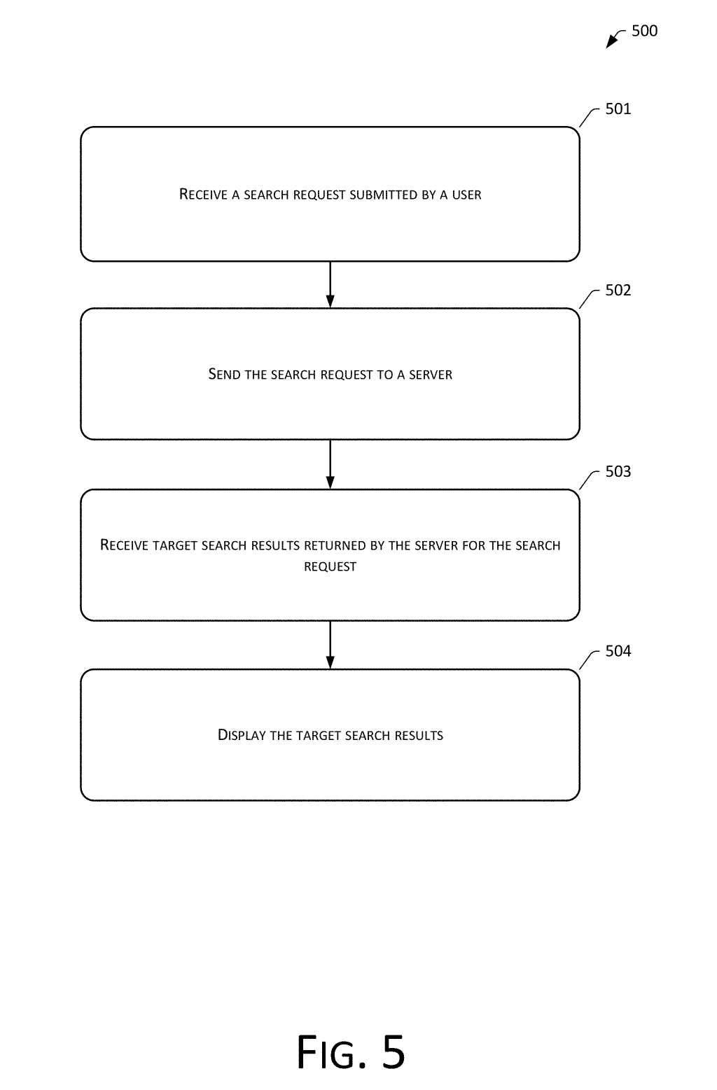

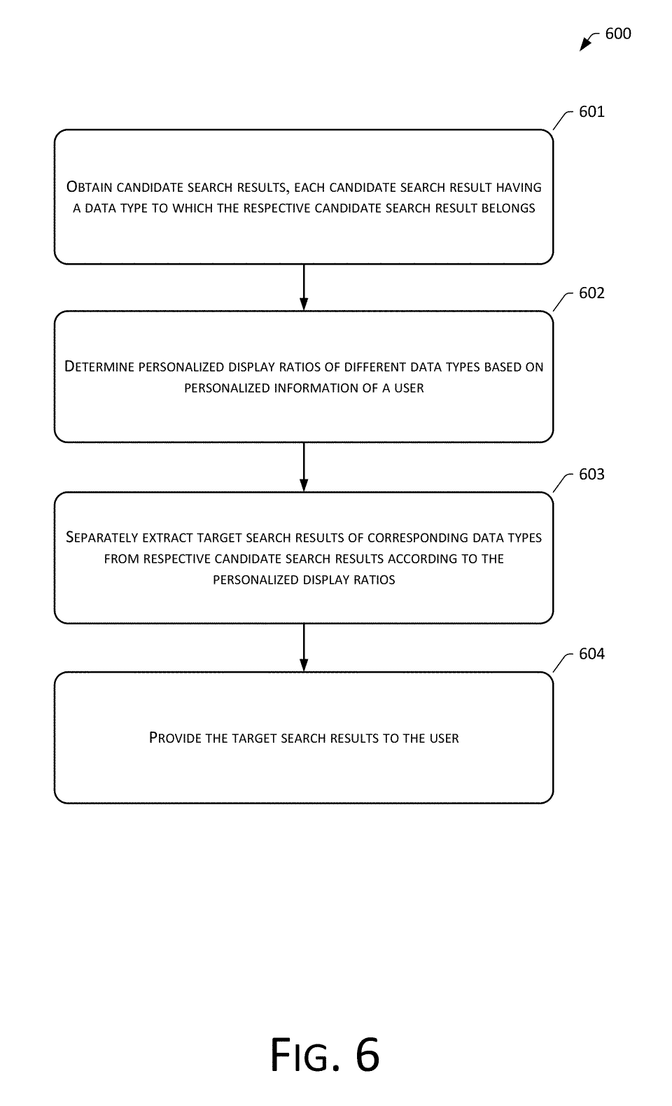

FIG. 6 shows a flowchart of a method 600 for displaying search results in accordance with a third embodiment the present disclosure, which may specifically include the following operations.

Operation 601: Obtain candidate search results, each candidate search result having a data type to which the respective candidate search result belongs.

Operation 602: Determine personalized display ratios of different data types based on personalized information of a user.

Operation 603: Separately extract target search results of corresponding data types from respective candidate search results according to the personalized display ratios.

Operation 604: Provide the target search results to the user.

In implementations, the data types may include a personalized data type, and obtaining the candidate search results may include the following sub-operations:

receiving a search request submitted by a client; and

retrieving candidate search results that are related to user information and are of the personalized data type for the search request.

The embodiments of the present disclosure propose an implementation that employs user personalized information (such as user identifier, real-time operations of a user, user preferences, etc.) as a guide, which can enable search results to be more in line with personalized needs of the user.

It should be noted that the method embodiments are all expressed as series of combinations of actions for the brevity of description. However, one skilled in the art should be understand that the embodiments of the present disclosure are not limited by the described orders of actions because some operations may be performed in other orders or simultaneously according to the embodiments of the present disclosure. Moreover, one skilled in the art should also understand that the embodiments described in the specification all belong to exemplary embodiments, and actions that are involved may not be necessarily required by the embodiments of the present disclosure.

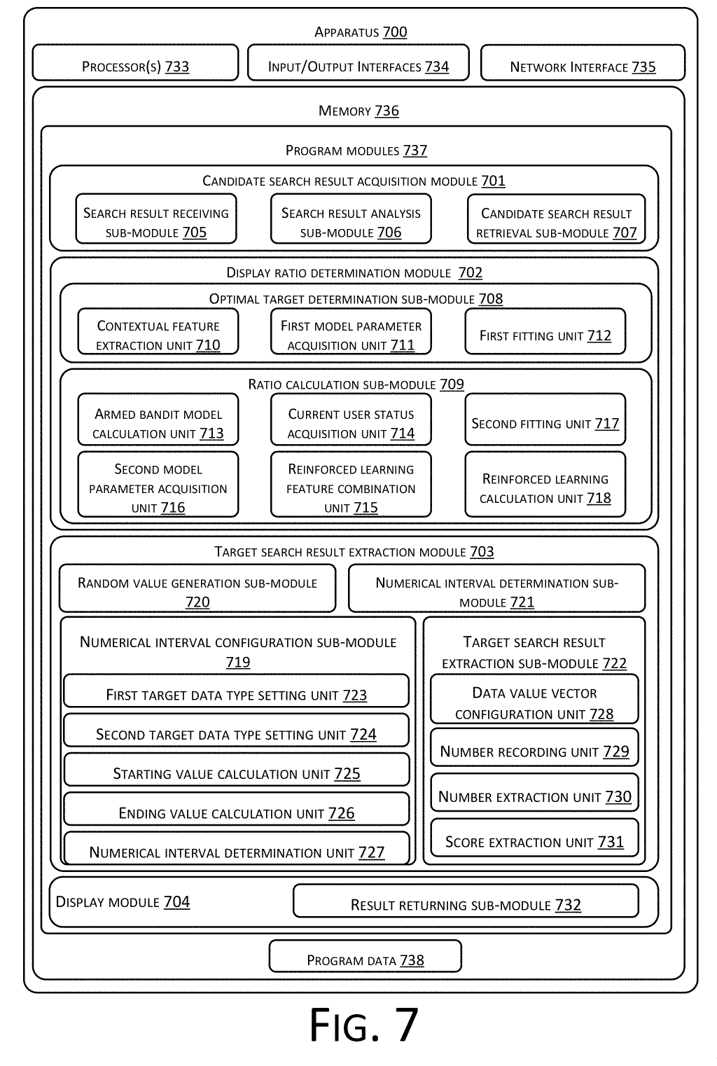

FIG. 7 shows a structural block diagram of an apparatus 700 for presenting search results according to the first embodiment of the present disclosure. In implementations, the apparatus 700 may include one or more computing devices. In implementations, the apparatus 700 may be a part of one or more computing devices, e.g., implemented or run by the one or more computing devices. In implementations, the one or more computing devices may be located in a single place or distributed among a plurality of network devices over a network. By way of example and not limitation, the apparatus 700 may include the following modules.

The candidate search result acquisition module 701 is used for obtaining candidate search results, each candidate search result having a data type to which the respective candidate search result belongs.

A display ratio determination module 702 is used for determining a display ratio of each data type.

A target search result extraction module 703 is used for separately extracting target search results of corresponding data types from the candidate search results according to the display ratio of each data type.

A display module 704 is used for displaying the target search results.

In implementations, the data types include non-personalized data type and personalized data type, and the candidate search result acquisition module 701 may include a search result receiving sub-module 705 used for receiving a search request submitted by a client; a search result analysis sub-module 706 used for extracting a keyword and user information from the search request; and a candidate search result retrieval sub-module 707 used for retrieving candidate search results that are related to the keyword and are of the non-personalized data type, and candidate search results that are related to the user information and are of the personalized data type for the search request.

In implementations, the display ratio determination module 702 may include an optimal target determination sub-module 708 used for determining optimal target parameters corresponding to different data types; and a ratio calculation sub-module 709 used for separately calculating display ratios of the different data types using the optimal target parameters.

In implementations, the optimal target determination sub-module 708 may include a contextual feature extraction unit 710 used for extracting a contextual feature of a user from the user information; a first model parameter acquisition unit 711 used for obtaining pre-trained first model parameters; and a first fitting unit 712 used for fitting the optimal target parameters of the data types based on the contextual feature of the user and the first model parameters.

The ratio calculation sub-module 709 may include an armed bandit model calculation unit 713 used for configuring display ratios of corresponding data types based on the optimal target parameters of the data types using a contextual multi-armed bandit model, wherein a data type corresponding an arm in the multi-armed bandit model.

In implementations, the contextual feature of the user may include user tag information and/or data types of search results associated with recent N clicks.

The first model parameters are trained using the following approach: collecting contextual features of the user and optimal target parameters of search results; and fitting optimal target parameters of the search results using data types as arms, the contextual features of the users, and a matrix w of which values are to be determined; and setting values of trained matrix Was the first model parameters.

In implementations, the ratio calculation sub-module 709 may further include a current user status acquisition unit 714 used for extracting a current user status from the user information; a reinforced learning feature combination unit 715 used for using the data types as actions and the current user status to form combined features; a second model parameter acquisition unit 716 used for obtaining pre-trained second model parameters; a second fitting unit 717 used for fitting first Q values using the combined features and the second model parameters under a condition of balancing one or more Q values corresponding to one or more user statuses, and setting the first Q values as optimal target parameters of the actions; and a reinforced learning calculation unit 718 used for calculating display ratios of data types corresponding to the actions according to the optimal target parameters of the actions.

In implementations, the user status may include user tag information and/or data types of search results associated with recent N clicks.

The second model parameters are trained using the following approach: collecting the current user status, a next user status, and optimal target parameters of search results; fitting second Q values using the data types as arms, the current user status, and a matrix w of which values are to be determined; fitting third Q values using the data types as arms, the next user status, and the matrix w of which the values are to be determined; generating an objective function using the optimal target parameters, the second Q values and the third Q values; optimizing the objective function, and calculating the values of the matrix w based on differences between the second Q values and the third Q values; and setting the values of the matrix w as the second model parameters.

In implementations, the target search result extraction module 703 may include a numerical interval configuration sub-module 719 used for configuring the data types with numerical intervals, ranges of the numerical intervals being positively correlated with the display ratios; a random value generation sub-module 720 used for generating a random value; a numerical interval determination sub-module 721 used for determining a numerical interval to which the random value belongs; and a target search result extraction sub-module 722 used for extracting target search results from candidate search results of a data type corresponding to the belonged numerical interval.

In implementations, the numerical interval configuration sub-module 719 may include a first target data type setting unit 723 used for setting a certain data type as a first target data type; a second target data type setting unit 724 used for setting data types arranged before the first target data type as second target data types; a starting value calculation unit 725 used for accumulating display ratios of the second target data types as a starting value; an ending value calculation unit 726 used for accumulating display ratios of the first target data types and the second target data types as an ending value; and a numerical interval determination unit 727 used for setting a region between the starting value and the ending value as a numerical interval of the first target data type.

In implementations, the target search result extraction sub-module 722 may include a data value vector configuration unit 728 used for configuring the data types with data value vectors; a number recording unit 729 used for recording a number to be displayed in a data value vector corresponding to the numerical interval to which the random value belongs; and a number extraction unit 730 used for extracting the target search results from the candidate search results of the data type corresponding to the belonged numerical interval according to the number to be displayed.

In implementations, the target search result extraction sub-module 722 may further include a score extraction unit 731 used for extracting refined service object data in an order of scores when the candidate search results belonging to the data type corresponding to the numerical interval is the refined service object data.

In implementations, the display module 704 may further include a result returning sub-module 732 used for returning the target search results to a client, the client being used for displaying the target search results.

In implementations, the apparatus 700 may also include one or more processors 733, an input/output (I/O) interface 734, a network interface 735, and memory 736.

The memory 736 may include a form of computer readable media such as a volatile memory, a random access memory (RAM) and/or a non-volatile memory, for example, a read-only memory (ROM) or a flash RAM. The memory 736 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 736 may include program modules 737 and program data 738. The program modules 737 may include one or more of the modules as described above with respect to FIG. 7.

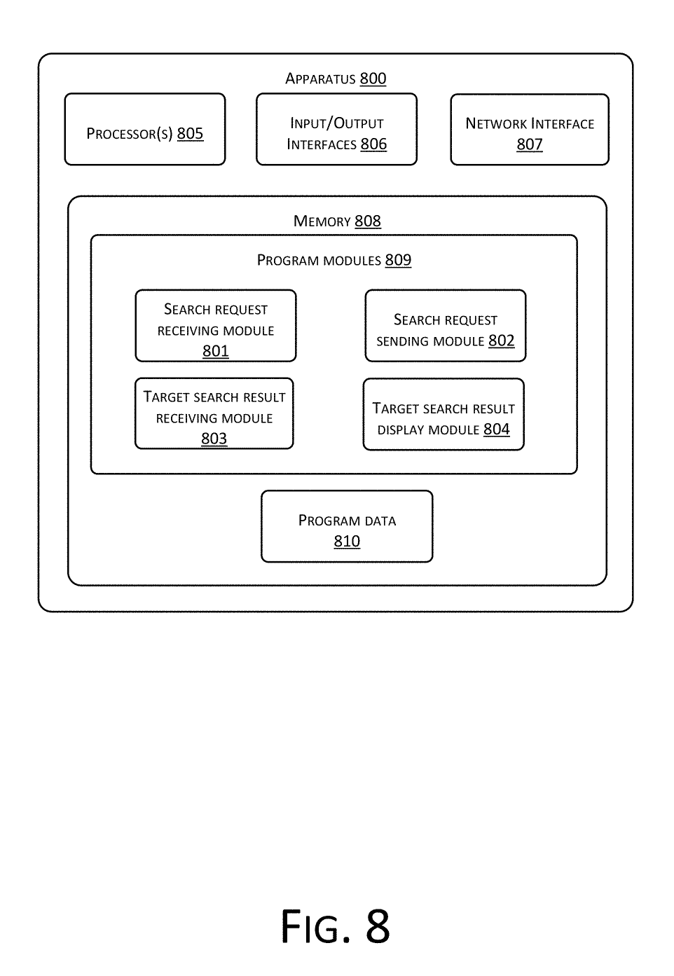

FIG. 8 shows a structural block diagram of an apparatus 800 of displaying search results in accordance with the second embodiment of the present disclosure. In implementations, the apparatus 800 may include one or more computing devices. In implementations, the apparatus 800 may be a part of one or more computing devices, e.g., implemented or run by the one or more computing devices. In implementations, the one or more computing devices may be located in a single place or distributed among a plurality of network devices over a network. By way of example and not limitation, the apparatus 800 may include a search request receiving module 801 used for receiving a search request submitted by a user; a search request sending module 802 used for sending the search request to a server; a target search result receiving module 803 used for receiving target search results returned by the server for the search request; and a target search result display module 804 used for displaying the target search results.

In the embodiments of the present disclosure, the target search results may be search results of corresponding data types that are separately extracted from candidate search results according to display ratios of different data types. The candidate search results may include retrieved candidate search results of a non-personalized data type that are related to a keyword in the search request, and candidate search results of a personalized data type that are related to user information in the search request.

In implementations, the apparatus 800 may also include one or more processors 805, an input/output (I/O) interface 806, a network interface 807, and memory 808.

The memory 808 may include a form of computer readable media as described in the foregoing description. In implementations, the memory 808 may include program modules 809 and program data 810. The program modules 809 may include one or more of the modules as described above with respect to FIG. 8.

Since the apparatus embodiments are basically similar to the method embodiments, a description is relatively simple. For related parts, reference may be made to respective portions of the description of the method embodiments.

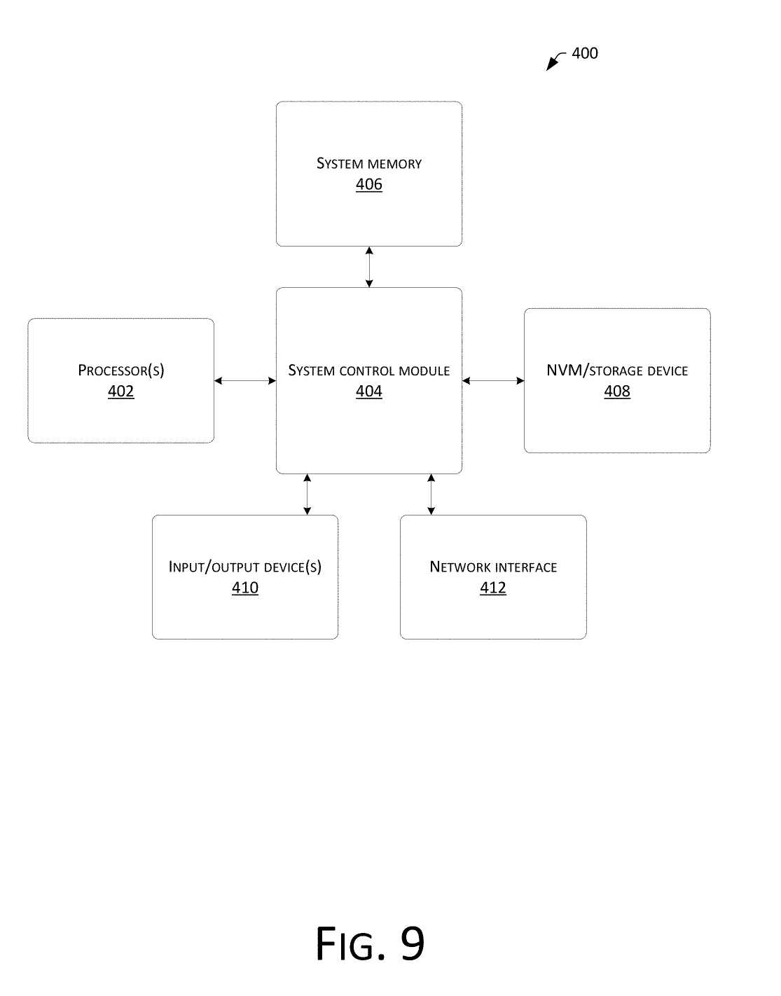

The embodiments of the present disclosure may be implemented as a system that uses any suitable hardware, firmware, software, or any combination thereof to perform a desired configuration. FIG. 9 schematically illustrates an exemplary apparatus (or system) 400 that may be used to implement the various embodiments described in the present disclosure.

In an embodiment, FIG. 9 shows an exemplary apparatus 400. The apparatus has one or more processors 402, a system control module (chipset) 404 coupled to at least one of the (one or more) processors 402, a system memory 406 coupled to the system control module 404, a non-volatile memory (NVM)/storage device 408 coupled to the system control module 404, and one or more input/output devices 410 coupled to the system control module 404, and a network interface 412 coupled to the system control module 406.

The processor 402 may include one or more single-core or multi-core processors. The processor 402 may include any combination of general-purpose processor(s) or special-purpose processor(s) (e.g., a graphics processor, an application processor, a baseband processor, etc.).

In some embodiments, the system 400 may include one or more computer-readable media (e.g., system memory 406 or a NVM/storage device 408) having instructions and the one or more processors 402 in combination with the one or more computer-readable media and configured to execute the instructions to implement module(s) to perform the actions described in the present disclosure.

In an embodiment, the system control module 404 may include any suitable interface controller to provide any suitable interface to at least one of the (one or more) processors 402 and/or any suitable device or component that communicates with the system control module 404.

The system control module 404 may include a memory controller module to provide an interface to the system memory 406. The memory controller module may be a hardware module, a software module, and/or a firmware module.

The system memory 406 may be used for loading and storing data and/or instructions for the system 400, for example. In one embodiment, the system memory 406 may include any suitable volatile memory, such as a suitable DRAM. In some embodiments, the system memory 406 may include double data rate type four-generation synchronous dynamic random access memory (DDR4 SDRAM).

In one embodiment, the system control module 404 may include one or more input/output controllers to provide an interface to the NVM/storage device 408 and (one or more) input devices 410.

For example, the NVM/storage device 408 may be used for storing data and/or instructions. The NVM/storage device 408 may include any suitable non-volatile memory (e.g., flash memory) and/or may include any suitable (one or more) nonvolatile storage devices (e.g., one or more hard disk drives (HDD), one or more compact disc (CD) drives, and/or one or more digital versatile disc (DVD) drives).

The NVM/storage device 408 may include a storage resource that is physically a part of a device installed in the system 400, or may be accessed by the device without necessarily being a part of the device. For example, the NVM/storage device 408 may be accessed via a network via the (one or more) input/output devices 410.

The (one or more) input/output devices 410 may provide an interface for the system 400 to communicate with any other suitable devices. The input/output devices 410 may include communication components, audio components, sensor components, and the like. The network interface 412 may provide an interface for the system 400 to conduct communications over one or more networks. The system 400 may conduct wireless communications with one or more components of a wireless network according to any one of one or more wireless network standards and/or protocols, such as accessing a wireless network based on a communication standard, such as WiFi, 2G, or 3G, or a combination thereof for wireless communications.

In one embodiment, at least one of the (one or more) processors 402 may be packaged with the logic of one or more controllers (e.g., memory controller modules) of the system control module 404. In one embodiment, at least one of the (one or more) processors 402 may be packaged with the logic of one or more controllers of the system control module 404 to form a system-in-package (SiP). In one embodiment, at least one of the (one or more) processors 402 may be integrated with the logic of one or more controllers of the system control module 404 on a same mold. In one embodiment, at least one of the (one or more) processors 402 may be integrated with the logic of one or more controllers of the system control module 404 on a same mold to form a system-on-a-chip (SoC).

In various embodiments, the system 400 may be, but is not limited to, a workstation, a desktop computing device, or a mobile computing device (e.g., a laptop computing device, a handheld computing device, a tablet, a netbook, etc.). In various embodiments, the system 400 may have more or fewer components and/or different architectures. For example, in some embodiments, the system 400 includes one or more cameras, keyboards, liquid crystal display (LCD) screens (including touch screen displays), non-volatile memory ports, multiple antennas, graphics chips, application specific integrated circuits (ASICs), and speakers.

The embodiments of the present disclosure further provide a non-volatile readable storage media. One or more modules (programs) are stored in the storage media. When the one or more modules are applied in a terminal device, the terminal device may be made to execute instructions of each method operation in the embodiments of the present disclosure.

In one example, an apparatus is provided and includes one or more processors, and one or more machine-readable media having instructions stored thereon that, when executed by the one or more processors, cause the apparatus to perform the method(s) in the embodiment(s) of the present disclosure.

In one example, one or more machine-readable media are also provided, which store instructions thereon that, when executed by one or more processors, cause the apparatus to perform method(s) in the embodiment(s) of the present disclosure.

Each embodiment in the present specification is described in a progressive manner, and each embodiment has an emphasis that is different from those of other embodiments. Same or similar parts among the embodiments can be referenced with each other.

One skilled in the art should understand that the embodiments of the present disclosure can be provided as a method, an apparatus, or a computer program product. Therefore, the embodiments of the present disclosure may take a form of a complete hardware embodiment, a complete software embodiment, or an embodiment that is a combination of software and hardware. Moreover, the embodiments of the present disclosure may take a form of a computer program product implemented in a form of one or more computer-usable storage media (which include, but are not limited to, a magnetic storage device, CD-ROM, an optical storage device, etc.) having computer-usable program codes embodied therein.

In a typical configuration, a computing device includes one or more processors (CPU), an input/output interface, a network interface, and memory. The memory may include a form of computer readable media such as a volatile memory, a random access memory (RAM) and/or a non-volatile memory, for example, a read-only memory (ROM) or a flash RAM. The memory is an example of a computer readable media. The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The embodiments of the present disclosure are described with reference to flowcharts and/or block diagrams of methods, terminal devices (systems), and computer program products according to the embodiments of the present disclosure. It should be understood that each flow and/or block in the flowcharts and/or block diagrams, and combinations of the flows and/or blocks in the flowcharts and/or block diagrams may be implemented by computer program instructions. The computer program instructions may be provided to a processor of a general purpose computer, a special purpose computer, an embedded processor, or other programmable data processing terminal device to produce a machine, such that an apparatus is created for implementing functions specified in one or more flows of a flowchart and/or one or more blocks of a block diagram through an execution of the instructions by the processor of the computer or other programmable data processing terminal device.

These computer program instructions may also be stored in a computer readable storage device capable of directing a computer or other programmable data processing terminal device to operate in a specific manner, so that instructions stored in the computer readable storage device generate an article of manufacture including an instruction apparatus. The instruction apparatus implements functions specified in one or more flows of a flowchart and/or one or more blocks of a block diagram.

These computer program instructions may also be loaded onto a computer or other programmable data processing terminal device, such that a series of operating operations are performed on the computer or other programmable terminal device to generate a computer-implemented process. The instructions executed in the computer or other programmable terminal device provide operations for implementing functions specified in one or more flows of a flowchart and/or one or more blocks of a block diagram.

Although the exemplary embodiments of the embodiments of the present disclosure have been described, one skilled in the art can make additional changes and modifications to these embodiments once the basic inventive concepts are learned. Therefore, the appended claims are intended to be interpreted as including the exemplary embodiments and all changes and modifications that fall within the scope of the embodiments of the present disclosure.

Finally, it should also be noted that relational terms such as first and second, etc., are only used to distinguish one entity or operation from another entity or operation in the present text, and do not necessarily require or imply an existence of any such relationship or order between these operations or entities. Moreover, terms “include”, “contain” or any other variations thereof are intended to cover a non-exclusive inclusion, such that a process, method, article, or terminal device that includes a series of elements includes not only these elements, but also includes other elements that are not explicitly listed, or also includes elements that are inherent in such process, method, article, or terminal device. Without any further limitation, an element defined by a statement “including a . . . ” does not exclude a process, method, article, or terminal device including the element from further including another identical element.

A method for displaying a search result, an apparatus for displaying a search result, an apparatus, and one or more computer-readable media provided in the present disclosure are described in detail above. The present text uses specific examples for illustrating the principles and implementations of the present disclosure. The description of the above embodiments is merely used for facilitating the understanding of the methods and the core ideas of the present disclosure. At the same time, for one of ordinary skill in the art, changes can be made to exemplary implementations and application scopes based on the ideas of the present disclosure. In summary, the content of the present specification should not be construed as limitations to the present disclosure.

The present disclosure can further be understood using the following clauses.

Clause 1: A method of displaying search results, comprising: obtaining candidate search results, each candidate search result having a data type to which the respective candidate search result belongs; determining a display ratio of each data type; separately extracting target search results of corresponding data types from the candidate search results according to the display ratio of each data type; and displaying the target search results.

Clause 2: The method of Clause 1, wherein the data types comprise a non-personalized data type and a personalized data type, and obtaining the candidate search results comprises: receiving a search request submitted by a client; extracting a keyword and user information from the search request; and retrieving candidate search results that are related to the keyword and are of the non-personalized data type, and candidate search results that are related to the user information and are of the personalized data type for the search request.

Clause 3: The method of Clause 1 or 2, wherein determining the display ratio of each data type comprises: determining optimal target parameters corresponding to different data types; and separately calculating display ratios of the different data types using the optimal target parameters.

Clause 4: The method of Clause 3, wherein: determining the optimal target parameters corresponding to the different data types comprises: extracting a contextual feature of a user from the user information; obtaining pre-trained first model parameters; and fitting the optimal target parameters of the data types based on the contextual feature of the user and the first model parameters, and separately calculating the display ratios of the different data types using the optimal target parameters comprises: configuring display ratios of corresponding data types based on the optimal target parameters of the data types using a contextual multi-armed bandit model, wherein a data type corresponding an arm in the multi-armed bandit model.

Clause 5: The method of Clause 4, wherein the contextual feature of the user includes user tag information and/or data types of search results associated with recent N clicks.

Clause 6: The method of Clause 4 or 5, wherein the first model parameters are trained using the following approach: collecting contextual features of the user and optimal target parameters of search results; fitting optimal target parameters of the search results using data types as arms, the contextual features of the users, and a matrix w of which values are to be determined; and setting values of trained matrix W as the first model parameter.

Clause 7: The method of Clause 4 or 5, wherein separately calculating the display ratios of the different data types using the optimal target parameters further comprises: extracting a current user status from the user information; using the data types as actions and the current user status to form combined features; obtaining pre-trained second model parameters; fitting first Q values using the combined features and the second model parameters under a condition of balancing one or more Q values corresponding to one or more user statuses, and setting the first Q values as optimal target parameters of the actions; and calculating display ratios of data types corresponding to the actions according to the optimal target parameters of the actions.

Clause 8: The method of Clause 7, wherein the user status includes user tag information and/or data types of search results associated with recent N clicks.

Clause 9: The method of Clause 7 or 8, wherein the second model parameters are trained using the following approach: collecting the current user status, a next user status, and optimal target parameters of search results; fitting second Q values using the data types as arms, the current user status, and a matrix w of which values are to be determined; fitting third Q values using the data types as arms, the next user status, and the matrix w of which the values are to be determined; generating an objective function using the optimal target parameters, the second Q values and the third Q values; optimizing the objective function, and calculating the values of the matrix w based on differences between the second Q values and the third Q values; and setting the values of the matrix w as the second model parameters.

Clause 10: The method of any one of Clauses 1-9, wherein separately extracting the target search results of the corresponding data types from the candidate search results according to the display ratio of each data type comprises: configuring the data types with numerical intervals, ranges of the numerical intervals being positively correlated with the display ratios; generating a random value; determining a numerical interval to which the random value belongs; and extracting target search results from candidate search results of a data type corresponding to the belonged numerical interval.

Clause 11: The method of Clause 10, wherein configuring the data types with numerical intervals comprises: setting a certain data type as a first target data type; setting data types arranged before the first target data type as second target data types; accumulating display ratios of the second target data types as a starting value; accumulating display ratios of the first target data types and the second target data types as an ending value; and setting a region between the starting value and the ending value as a numerical interval of the first target data type.

Clause 12: The method of Clause 11, wherein extracting the target search results from the candidate search results of the data type corresponding to the belonged numerical interval comprises: configuring the data types with data value vectors; recording a number to be displayed in a data value vector corresponding to the numerical interval to which the random value belongs; and extracting the target search results from the candidate search results of the data type corresponding to the belonged numerical interval according to the number to be displayed.

Clause 13: The method of any one of Clauses 1-9, wherein displaying the target search results comprises returning the target search results to a client, the client being used for displaying the target search results.

Clause 14: A method of displaying search results, comprising: receiving a search request submitted by a user; sending the search request to a server; receiving target search results returned by the server for the search request, wherein the target search results are search results of corresponding data types that are separately extracted from candidate search results according to display ratios of different data types, the candidate search results include retrieved candidate search results of a non-personalized data type that are related to a keyword in the search request, and candidate search results of a personalized data type that are related to user information in the search request; and displaying the target search results.

Clause 15: A method of displaying search results, comprising: obtaining candidate search results, each candidate search result having a data type to which the respective candidate search result belongs; determining personalized display ratios of different data types based on personalized information of a user; separately extracting target search results of corresponding data types from the candidate search results according to personalized display ratios; and providing the target search results to the user.

Clause 16: An apparatus of displaying search results, comprising: a candidate search result acquisition module used for obtaining candidate search results, each candidate search result having a data type to which the respective candidate search result belongs; a display ratio determination module used for determining a display ratio of each data type; a target search result extraction module used for separately extracting target search results of corresponding data types from the candidate search results according to the display ratio of each data type; and a display module used for displaying the target search results.

Clause 17: The apparatus of Clause 16, wherein the data types include a non-personalized data type and a personalized data type, and the candidate search result acquisition module comprises: a search result receiving sub-module used for receiving a search request submitted by a client; a search result analysis sub-module used for extracting a keyword and user information from the search request; and a candidate search result retrieval sub-module used for retrieving candidate search results that are related to the keyword and are of the non-personalized data type, and candidate search results that are related to the user information and are of the personalized data type for the search request.

Clause 18: The apparatus of Clause 16 or 17, wherein the display ratio determination module comprises: an optimal target determination sub-module used for determining optimal target parameters corresponding to different data types; and a ratio calculation sub-module used for separately calculating display ratios of the different data types using the optimal target parameters.

Clause 19: The apparatus of Clause 18, wherein: the optimal target determination sub-module comprises: a contextual feature extraction unit used for extracting a contextual feature of a user from the user information; a first model parameter acquisition unit used for obtaining pre-trained first model parameters; and a first fitting unit used for fitting the optimal target parameters of the data types based on the contextual feature of the user and the first model parameters, and the ratio calculation sub-module comprises: an armed bandit model calculation unit used for configuring display ratios of corresponding data types based on the optimal target parameters of the data types using a contextual multi-armed bandit model, wherein a data type corresponding an arm in the multi-armed bandit model.

Clause 20: The apparatus of Clause 19, wherein the contextual feature of the user includes user tag information and/or data types of search results associated with recent N clicks.

Clause 21: The apparatus of Clause 19 or 20, wherein the first model parameters are trained using the following approach: collecting contextual features of the user and optimal target parameters of search results; fitting optimal target parameters of the search results using data types as arms, the contextual features of the users, and a matrix w of which values are to be determined; and setting values of trained matrix W as the first model parameter.

Clause 22: The apparatus of Clause 19 or 20, wherein the ratio calculation sub-module comprises: a current user status acquisition unit used for extracting a current user status from the user information; a reinforced learning feature combination unit used for using the data types as actions and the current user status to form combined features; a second model parameter acquisition unit used for obtaining pre-trained second model parameters; a second fitting unit used for fitting first Q values using the combined features and the second model parameters under a condition of balancing one or more Q values corresponding to one or more user statuses, and setting the first Q values as optimal target parameters of the actions; and a reinforced learning calculation unit used for calculating display ratios of data types corresponding to the actions according to the optimal target parameters of the actions.

Clause 23: The apparatus of Clause 22, wherein the second model parameters are trained using the following approach: collecting the current user status, a next user status, and optimal target parameters of search results; fitting second Q values using the data types as arms, the current user status, and a matrix w of which values are to be determined; fitting third Q values using the data types as arms, the next user status, and the matrix w of which the values are to be determined; generating an objective function using the optimal target parameters, the second Q values and the third Q values; optimizing the objective function, and calculating the values of the matrix w based on differences between the second Q values and the third Q values; and setting the values of the matrix w as the second model parameters.

Clause 24: The apparatus of any one of Clauses 16-23, wherein the target search result extraction module comprises: a numerical interval configuration sub-module used for configuring the data types with numerical intervals, ranges of the numerical intervals being positively correlated with the display ratios; a random value generation sub-module used for generating a random value; a numerical interval determination sub-module used for determining a numerical interval to which the random value belongs; and a target search result extraction sub-module used for extracting target search results from candidate search results of a data type corresponding to the belonged numerical interval.

Clause 25: The apparatus of Clause 24, wherein the numerical interval configuration sub-module comprises: a first target data type setting unit used for setting a certain data type as a first target data type; a second target data type setting unit used for setting data types arranged before the first target data type as second target data types; a starting value calculation unit used for accumulating display ratios of the second target data types as a starting value; an ending value calculation unit used for accumulating display ratios of the first target data types and the second target data types as an ending value; and a numerical interval determination unit used for setting a region between the starting value and the ending value as a numerical interval of the first target data type.

Clause 26: The apparatus of Clause 24, wherein the target search result extraction sub-module comprises: a data value vector configuration unit used for configuring the data types with data value vectors; a number recording unit used for recording a number to be displayed in a data value vector corresponding to the numerical interval to which the random value belongs; and a number extraction unit used for extracting the target search results from the candidate search results of the data type corresponding to the belonged numerical interval according to the number to be displayed.

Clause 27: The apparatus of any one of Clauses 16-23, wherein the display module comprises a result returning sub-module used for returning the target search results to a client, the client being used for displaying the target search results.

Clause 28: An apparatus of displaying search results, comprising: a search request receiving module used for receiving a search request submitted by a user; a search request sending module used for sending the search request to a server; a target search result receiving module used for receiving target search results returned by the server for the search request, wherein the target search results are search results of corresponding data types that are separately extracted from candidate search results according to display ratios of different data types, the candidate search results include retrieved candidate search results of a non-personalized data type that are related to a keyword in the search request, and candidate search results of a personalized data type that are related to user information in the search request; and a target search result display module used for displaying the target search results.

Clause 29: An apparatus comprising: one or more processors; and one or more computer readable media storing instructions that, when executed by the one or more processors, cause the apparatus to perform one or more methods of Clauses 1-15.

Clause 30: One or more computer readable media storing instructions that, when executed by one or more processors, cause a terminal to perform one or more methods of Clauses 1-15.

What is claimed is:

1. A method implemented by one or more computing devices, the method comprising:
obtaining candidate search results, each candidate search result having a data type to which the respective candidate search result belongs;
determining a display ratio of each data type;
separately extracting target search results of corresponding data types from the candidate search results according to the display ratio of each data type; and
displaying the target search results.

2. The method of claim 1, wherein the data types comprise a non-personalized data type and a personalized data type, and obtaining the candidate search results comprises:
receiving a search request submitted by a client;
extracting a keyword and user information from the search request; and
retrieving candidate search results that are related to the keyword and are of the non-personalized data type, and candidate search results that are related to the user information and are of the personalized data type for the search request.

3. The method of claim 1, wherein determining the display ratio of each data type comprises:
determining optimal target parameters corresponding to different data types; and
separately calculating display ratios of the different data types using the optimal target parameters.

4. The method of claim 3, wherein:
determining the optimal target parameters corresponding to the different data types comprises:
extracting a contextual feature of a user from the user information;
obtaining pre-trained first model parameters; and
fitting the optimal target parameters of the data types based on the contextual feature of the user and the first model parameters, and
separately calculating the display ratios of the different data types using the optimal target parameters comprises:
configuring display ratios of corresponding data types based on the optimal target parameters of the data types using a contextual multi-armed bandit model, wherein a data type corresponding an arm in the multi-armed bandit model.

5. The method of claim 4, wherein the contextual feature of the user includes user tag information and/or data types of search results associated with recent N clicks.

6. The method of claim 4, wherein the first model parameters are trained by:
collecting contextual features of the user and optimal target parameters of search results;
fitting optimal target parameters of the search results using data types as arms, the contextual features of the users, and a matrix w of which values are to be determined; and
setting values of trained matrix W as the first model parameter.

7. The method of claim 4, wherein separately calculating the display ratios of the different data types using the optimal target parameters further comprises:
extracting a current user status from the user information;
using the data types as actions and the current user status to form combined features; obtaining pre-trained second model parameters;
fitting first Q values using the combined features and the second model parameters under a condition of balancing one or more Q values corresponding to one or more user statuses, and setting the first Q values as optimal target parameters of the actions; and
calculating display ratios of data types corresponding to the actions according to the optimal target parameters of the actions.

8. The method of claim 7, wherein the user status includes user tag information and/or data types of search results associated with recent N clicks.

9. The method of claim 7, wherein the second model parameters are trained using by:
collecting the current user status, a next user status, and optimal target parameters of search results;
fitting second Q values using the data types as arms, the current user status, and a matrix w of which values are to be determined;
fitting third Q values using the data types as arms, the next user status, and the matrix w of which the values are to be determined;
generating an objective function using the optimal target parameters, the second Q values and the third Q values;
optimizing the objective function, and calculating the values of the matrix w based on differences between the second Q values and the third Q values; and
setting the values of the matrix w as the second model parameters.

10. The method of claim 1, wherein separately extracting the target search results of the corresponding data types from the candidate search results according to the display ratio of each data type comprises:
configuring the data types with numerical intervals, ranges of the numerical intervals being positively correlated with the display ratios;
generating a random value;
determining a numerical interval to which the random value belongs; and
extracting target search results from candidate search results of a data type corresponding to the belonged numerical interval.

11. The method of claim 10, wherein configuring the data types with numerical intervals comprises:
setting a certain data type as a first target data type;
setting data types arranged before the first target data type as second target data types;
accumulating display ratios of the second target data types as a starting value;
accumulating display ratios of the first target data types and the second target data types as an ending value; and
setting a region between the starting value and the ending value as a numerical interval of the first target data type.

12. The method of claim 11, wherein extracting the target search results from the candidate search results of the data type corresponding to the belonged numerical interval comprises:
configuring the data types with data value vectors;
recording a number to be displayed in a data value vector corresponding to the numerical interval to which the random value belongs; and
extracting the target search results from the candidate search results of the data type corresponding to the belonged numerical interval according to the number to be displayed.

13. The method of claim 1, wherein displaying the target search results comprises returning the target search results to a client, the client being used for displaying the target search results.

14. One or more computer readable media storing executable instructions that, when executed by one or more processors, cause the one or more processors to perform acts comprising:
receiving a search request submitted by a user;
sending the search request to a server;
receiving target search results returned by the server for the search request, wherein the target search results are search results of corresponding data types that are separately extracted from candidate search results according to display ratios of different data types, the candidate search results include retrieved candidate search results of a non-personalized data type that are related to a keyword in the search request, and candidate search results of a personalized data type that are related to user information in the search request; and displaying the target search results.

15. An apparatus comprising:
one or more processors;
memory;
a candidate search result acquisition module stored in the memory and executable by the one or more processors to obtain candidate search results, each candidate search result having a data type to which the respective candidate search result belongs;
a display ratio determination module in the memory and executable by the one or more processors to determine a display ratio of each data type;
a target search result extraction module in the memory and executable by the one or more processors to separately extract target search results of corresponding data types from the candidate search results according to the display ratio of each data type; and
a display module in the memory and executable by the one or more processors to display the target search results.

16. The apparatus of claim 15, wherein the data types include a non-personalized data type and a personalized data type, and the candidate search result acquisition module comprises:
a search result receiving sub-module used for receiving a search request submitted by a client;
a search result analysis sub-module used for extracting a keyword and user information from the search request; and
a candidate search result retrieval sub-module used for retrieving candidate search results that are related to the keyword and are of the non-personalized data type, and candidate search results that are related to the user information and are of the personalized data type for the search request.

17. The apparatus of claim 15, wherein the display ratio determination module comprises:
an optimal target determination sub-module used for determining optimal target parameters corresponding to different data types; and
a ratio calculation sub-module used for separately calculating display ratios of the different data types using the optimal target parameters.

18. The apparatus of claim 17, wherein:
the optimal target determination sub-module comprises:
a contextual feature extraction unit used for extracting a contextual feature of a user from the user information;
a first model parameter acquisition unit used for obtaining pre-trained first model parameters; and
a first fitting unit used for fitting the optimal target parameters of the data types based on the contextual feature of the user and the first model parameters, and
the ratio calculation sub-module comprises:
an armed bandit model calculation unit used for configuring display ratios of corresponding data types based on the optimal target parameters of the data types using a contextual multi-armed bandit model, wherein a data type corresponding an arm in the multi-armed bandit model.

19. The apparatus of claim 18, wherein the first model parameters are trained by:
collecting contextual features of the user and optimal target parameters of search results;
fitting optimal target parameters of the search results using data types as arms, the contextual features of the users, and a matrix w of which values are to be determined; and
setting values of trained matrix W as the first model parameter.

20. The apparatus of claim 18, wherein the ratio calculation sub-module comprises:
a current user status acquisition unit used for extracting a current user status from the user information;
a reinforced learning feature combination unit used for using the data types as actions and the current user status to form combined features;
a second model parameter acquisition unit used for obtaining pre-trained second model parameters;
a second fitting unit used for fitting first Q values using the combined features and the second model parameters under a condition of balancing one or more Q values corresponding to one or more user statuses, and setting the first Q values as optimal target parameters of the actions; and
a reinforced learning calculation unit used for calculating display ratios of data types corresponding to the actions according to the optimal target parameters of the actions.
